(19) United States
(12) Patent Application Publication
(10) Pub. No.: US 2004/0077757 A1
(43) Pub. Date: Apr. 22, 2004

(54) Coating composition for use in producing an insulating thin film

(76) Inventors: Toru Araki, Fuji-shi (JP); Jun Li, Fuji-shi (JP); Hironobu Shirataki, Fuji-shi (JP); Hiroyuki Hanahata, Shizuoka-shi (JP); Shinya Matsuno, Fuji-shi (JP)

Correspondence Address: BIRCH STEWART KOLASCH & BIRCH, PO BOX 747, FALLS CHURCH, VA, 22040-0747, US

(21) Appl. No.: 10/359,169

(22) Filed: Feb. 6, 2003

(30) Foreign Application Priority Data
Feb. 6, 2002 (JP) 2002-029966
Feb. 6, 2002 (JP) 2002-029971

(51) Int. Cl. C08K 5/24

(52) U.S. Cl. 524/264; 524/261; 524/269; 524/589

(57) ABSTRACT

Disclosed is a coating composition comprising: (A) a silica precursor comprising at least one member selected from the group consisting of alkoxysilanes and hydrolysis/polycondensation products formed by hydrolysis/polycondensation reactions of the alkoxysilanes under acidic conditions, and (B) an organic polymer containing 20% by weight or more, based on the weight of the organic polymer, of an organic block copolymer, wherein the coating composition has an acidic pH value.

Also disclosed is a coating composition which, in addition to the above-mentioned silica precursor and organic polymer, comprises an acid having an electrolytic dissociation exponent (pKa) of from 1 to 11 and a quaternary ammonium salt.

Further, disclosed are a porous silica insulating thin film, a multilevel interconnect and a semiconductor device, which are obtained from the above-mentioned coating compositions.

### BACKGROUND OF THE INVENTION

1. Field of the Invention

The present invention relates to a coating composition for use in producing an insulating thin film, which comprises a silica precursor and an organic polymer containing a specific amount of an organic block copolymer, wherein the silica precursor comprises at least one member selected from the group consisting of specific alkoxysilanes and hydrolysis/polycondensation products formed by hydrolysis/polycondensation reactions of the alkoxysilanes under acidic conditions and wherein the coating composition has an acidic pH value and exhibits excellent storage stability. By using the coating composition of the present invention, it becomes possible to produce a porous silica insulating thin film which exhibits a satisfactorily low relative dielectric constant, an extremely high mechanical strength, and excellent processability. The present invention is also concerned with a coating composition which, in addition to the above-mentioned silica precursor and organic polymer, comprises an acid having an electrolytic dissociation exponent (pKa) of from 1 to 11 and a quaternary ammonium salt. Further, the present invention is also concerned with a porous silica insulating thin film obtained using the above-mentioned coating composition. Still further, the present invention is also concerned with an insulating laminate structure comprising the porous silica insulating thin film, a multilevel interconnect comprising the porous silica insulating thin film, and a semiconductor device comprising the multilevel interconnect.

2. Prior Art

A porous silica has various excellent properties, such as lightweight and excellent heat resistance. Therefore, a porous silica has been widely used in a structural material, a support for a catalyst, an optical material and the like.

On the other hand, recently, a porous silica has been drawing attention to a property thereof which is advantageous in that the relative dielectric constant of the porous silica can be lowered. Conventionally, as a material for an insulating thin film for a multilevel interconnect for a semiconductor device (such as an LSI), a high density silica material has generally been used. In recent years, however, the density of the circuit of a semiconductor device (such as an LSI) has become higher and, hence, the distance between mutually adjacent conducting lines in the circuit has become extremely small. Due to this high density circuitry, the mutually adjacent conducting lines having insulators therebetween function as a capacitor. This poses a problem that, when the relative dielectric constant of the insulator is high, the electrostatic capacity of the capacitor formed by the mutually adjacent conducting lines and the insulators present therebetween becomes high, so that the transmission of the electric signals through each of the mutually adjacent conducting lines is markedly delayed. In view of this, as a material for an insulating thin film for a multilevel interconnect, it is strongly desired to use a material having a lower relative dielectric constant. Further, instead of aluminum which has conventionally been used as a material for conducting lines, the use of copper as a material for conducting lines has begun, wherein copper has a lower resistance than aluminum. This also necessitates the use of a material having a lower relative dielectric constant as a material for an insulating thin film for a multilevel interconnect.

In an attempt to provide a method for producing an insulating thin film comprising a porous silica having a uniform pore diameter, Unexamined Japanese Patent Application Laid-Open Specification Nos. 2001-49174, 2001-49176, 2001-19903 and 2002-26003, and WO99/03926 disclose coating compositions which comprise an alkoxysilane having a specific structure and an organic polymer.

In general, from the viewpoint of producing a porous silica insulating thin film having a uniform thickness from a coating composition, it is very important for the coating composition to have high storage stability. The coating compositions disclosed in the above-mentioned patent documents exhibit relatively high storage stability. However, the porous silica insulating thin films obtained from the coating compositions disclosed in the above-mentioned patent documents have the following disadvantages. In general, a porous silica insulating thin film is required to have, as one of the most important properties thereof, a satisfactorily low relative dielectric constant. Further, a porous silica insulating thin film is required to have an extremely high mechanical strength so that the porous silica insulating thin film can be successfully processed in a CMP (Chemical Mechanical Polishing) process. However, such an excellent porous silica insulating thin film having both a satisfactorily low relative dielectric constant and a very high mechanical strength cannot be obtained from the coating compositions disclosed in above-mentioned patent documents. With respect to the CMP process and the reason why a porous silica insulating thin film to be subjected to the CMP process needs to have a very high mechanical strength, an explanation is made below. A porous silica insulating thin film is subjected to etching to form grooves therein, and copper is embedded in the grooves to form a circuit of copper, thereby obtaining a copper-embedded thin film. In embedding copper in the grooves, superfluous copper spreads over the porous silica insulating thin film. The superfluous copper spreading over the insulating thin film must be removed from the copper-embedded thin film by abrading the surface of the superfluous copper so that all copper other than the copper embedded in the groove is removed and the resultant copper-embedded thin film becomes flat. The CMP process means the abrasion process of the surface of the superfluous copper. In this connection, it should be noted that, in general, a barrier thin film of silicon nitride having a thickness of several hundred angstroms to several thousand angstroms is formed on the porous silica insulating thin film, and the resultant, silicon nitride-clad insulating thin film is subjected to etching to form grooves in the silicon nitride-clad insulating thin film, followed by embedding of copper. In the CMP process, compression stress and shear stress are sustained on the porous silica insulating thin film and the barrier thin film. Therefore, the porous silica insulating thin film is required to have a very high mechanical strength.

Further, each of the coating compositions disclosed in the above-mentioned patent documents has the following disadvantage. The porous silica insulating thin film is obtained by removing the organic polymer from a silica/organic polymer composite thin film obtained from the coating composition. The heating temperature for removing the organic polymer needs to be as high as 450° C. or more. It is very difficult to satisfactorily practice the process for producing a semiconductor device under such high temperature conditions.

The reason why the heating temperature for removing the organic polymer needs to be 450° C. or more is as follows. Taking into consideration the oxidation of a metal (such as copper) used as a material for conducting lines, multicrystallization of the metal, and heat stress in the metal, it is recommended that the heating be conducted at a temperature not higher than about 400° C. in a non-oxidating atmosphere. However, when the heating is conducted at such a temperature, most of the organic polymer in the silica/organic polymer composite is likely to remain unreacted or in the form of a char in the resultant porous silica insulating thin film, wherein the char means a carbonaceous substance which remains as an unreacted substance in the thermal decomposition of the organic polymer. The organic polymer remaining unreacted or in the form of a char in the porous silica insulating thin film poses the following problem. In an insulating laminate structure comprising the porous silica insulating thin film wherein the insulating laminate structure has formed therethrough a via hole, when a via circuit is formed therein by embedding a metal in the via hole (such a structure having formed therein a via circuit is described in FIG. 1), gas which is derived from the organic polymer remaining in the porous silica thin film is generated from the porous silica thin film layer of the laminate structure, leading to a danger such that the adhesion between the porous silica thin film layer and a layer (of the laminate structure) adjacent to the porous silica thin film layer is lowered or that the adjacent layer is detached from the porous silica thin film layer.

For avoiding such danger, the use of an organic polymer containing a nitro compound which is susceptible to thermal decomposition is considered. However, the use of such an organic polymer is likely to cause various problems. For example, the organic polymer is thermally too sensitive, so that even a slight thermal change is likely to cause rapid decomposition of the organic polymer. Therefore, handling of the organic polymer is very dangerous. Further, a catalyst used for a sol-gel reaction is likely to cause a lowering of the molecular weight of the organic polymer, leading to a deterioration of the film-forming property of the organic polymer. Moreover, the compatibility of the polymer with the silica precursor is poor, so that the polymer is likely to be deposited from the coating composition or that the polymer is likely to be decomposed and/or volatilized during the formation of a silica/organic polymer composite thin film and, hence, the formed thin film becomes dense. Therefore, under conditions wherein the heating temperature is not higher than about 400° C., it is very difficult to produce a practical porous silica insulating thin film. (In the above description, the “sol-gel reaction” means a reaction in which a sol (i.e., a colloid-like dispersion of particles in a liquid) is formed as an intermediate and then transformed into a gel in a solid form.)

As apparent from the above, by the prior art, it has been impossible to obtain a porous silica insulating thin film which is produced from a coating composition having excellent storage stability and which exhibits very low relative dielectric constant and an extremely high mechanical strength (which enables the thin film to be successfully processed in a CMP process), wherein the amount of gas generated from the porous silica insulating thin film during formation of an insulating laminate structure using the thin film can be suppressed to an extremely low level.

### SUMMARY OF THE INVENTION

In this situation, the present inventors have made extensive and intensive studies with a view toward developing a coating composition for use in an insulating thin film, and a porous silica insulating thin film produced from the coating composition, wherein the coating composition exhibits excellent storage stability, wherein the porous silica insulating thin film exhibits excellent hydrophobicity, a stably low relative dielectric constant and an extremely high mechanical strength (which enables the thin film to be successfully processed in a CMP process in the formation of a copper circuit in a semiconductor device), and wherein the amount of gas generated from the porous silica insulating thin film during the via process (i.e., the process for forming a via circuit in an insulating laminate structure comprising the porous silica insulating thin film) can be suppressed to an extremely low level (that is, in the present invention, the “excellent processability” means that not only is the porous silica insulating thin film successfully processed in the CMP process, but also the amount of gas generated from the porous silica insulating thin film during the via process can be suppressed to an extremely low level). As a result, it has unexpectedly been found that the desired porous silica insulating thin film can be produced from a coating composition comprising:

(A) a silica precursor comprising at least one member selected from the group consisting of specific alkoxysilanes, and hydrolysis/polycondensation products formed by hydrolysis/polycondensation reactions of the alkoxysilanes under acidic conditions, and

(B) an organic polymer containing 20% by weight or more, based on the weight of the organic polymer, of a straight chain or branched organic block copolymer. Based on this finding, the present invention has been completed.

Accordingly, it is a primary object of the present invention to provide a coating composition exhibiting excellent storage stability, which enables production therefrom a porous silica insulating thin film which exhibits excellent hydrophobicity, a stably low relative dielectric constant and an extremely high mechanical strength (which enables the thin film to be successfully processed in a CMP process in the formation of a copper circuit in a semiconductor device), wherein the amount of gas generated from the porous silica insulating thin film during the via process can be suppressed to an extremely low level.

It is another object of the present invention to provide a method for producing a porous silica insulating thin film having the above-mentioned desired properties by using the coating composition.

The foregoing and other objects, features and advantages of the present invention will be apparent from the following detailed description and appended claims taken in connection with the accompanying drawings.

### BRIEF DESCRIPTION OF THE DRAWINGS

In the drawings:

FIG. 1 is a vertical cross-sectional view of an embodiment of the insulating laminate structure of the present invention, which comprises the porous silica insulating thin film of the present invention; and

FIG. 2 is a vertical cross-sectional view of another embodiment of the insulating laminate structure of the present invention, which comprises the porous silica insulating thin film of the present invention.

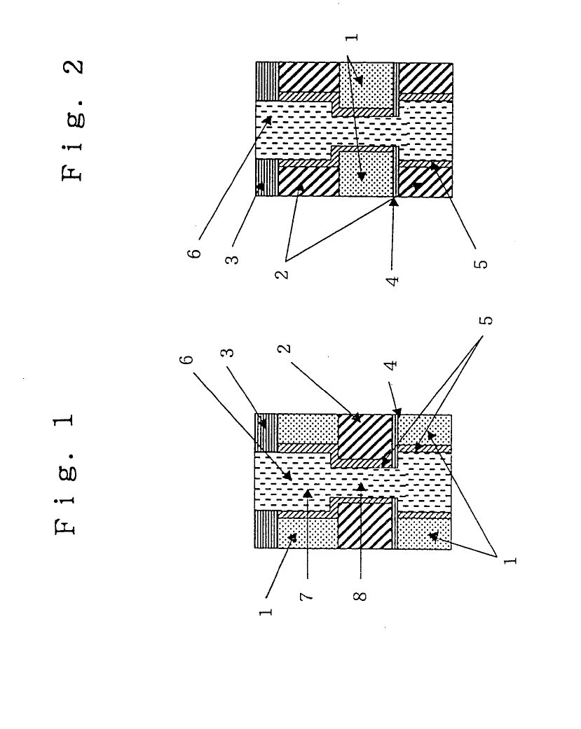

In FIGS. 1 and 2, like parts or portions are indicated by like reference numerals.

### DESCRIPTION OF REFERENCE NUMERALS

1: Porous silica insulating thin film

2: Organic compound thin film

3: Hard mask

4: Diffusion prevention layer

5: Barrier metal

6: Cu circuit portion

7: Trench circuit portion

8: Via circuit portion

### DETAILED DESCRIPTION OF THE INVENTION

According to the present invention, there is provided a coating composition for use in producing an insulating thin film, comprising:

(A) a silica precursor comprising at least one member selected from the group consisting of specific alkoxysilanes, and hydrolysis/polycondensation products formed by hydrolysis/polycondensation reactions of the alkoxysilanes under acidic conditions, and

(B) an organic polymer containing 20% by weight or more, based on the weight of the organic polymer, of a straight chain or branched organic block copolymer,

wherein the coating composition exhibits excellent storage stability, wherein by the use of the coating composition, it becomes possible to produce a porous silica insulating thin film which exhibits a satisfactorily low relative dielectric constant, extremely high mechanical strength and excellent processability.

For easy understanding of the present invention, the essential features and various preferred embodiments of the present invention are enumerated below.

1. A coating composition for use in producing an insulating thin film, comprising:

(A) a silica precursor comprising at least one member selected from the group consisting of an alkoxysilane (a), an alkoxysilane (b), and hydrolysis/polycondensation products formed by hydrolysis/polycondensation reactions of the alkoxysilanes (a) and (b) under acidic conditions,

wherein:

the alkoxysilane (a) is represented by the following formula (1):

R¹ₙSi(OR²)₄₋ₙ (1)

wherein each R¹ independently represents a hydrogen atom, a straight chain or branched alkyl group having 1 to 6 carbon atoms, a vinyl group or a phenyl group, each R² independently represents a straight chain or branched alkyl group having 1 to 6 carbon atoms and n represents an integer of from 0 to 3, and

the alkoxysilane (b) is represented by the following formula (2):

R³ₘ(R⁴O)₃₋ₘSi—(R⁷)ₚ—Si(OR⁵)_{3-q}R⁶_{q} (2)

wherein each R³ independently represents a hydrogen atom, a straight chain or branched alkyl group having 1 to 6 carbon atoms, a vinyl group or a phenyl group, each R⁴ independently represents a straight chain or branched alkyl group having 1 to 6 carbon atoms, each R⁵ independently represents a straight chain or branched alkyl group having 1 to 6 carbon atoms, each R⁶ independently represents a hydrogen atom, a straight chain or branched alkyl group having 1 to 6 carbon atoms, a vinyl group or a phenyl group, R⁷ represents an oxygen atom, a phenylene group, or a group —(CH₂)ᵣ— in which r represents an integer of from 1 to 6, each of m and q independently represents an integer of from 0 to 2, and p represents 0 or 1; and

(B) an organic polymer containing 20% by weight or more, based on the weight of the organic polymer, of a straight chain or branched organic block copolymer, the hydrolysis/polycondensation reactions for obtaining the silica precursor (A) being performed in the presence of the organic polymer (B),

the coating composition having a pH value of less than 7.

2. The coating composition according to item 1 above, wherein the organic block copolymer has at least one terminal group which is inert to the silica precursor (A).

3. The coating composition according to item 1 or 2 above, wherein the organic block copolymer contains a structure represented by the following formula (3):

—(R⁸O)ₓ—(R¹⁰O)_{y}—(R⁹O)_{z}— (3)

wherein each of R⁸, R⁹ and R¹⁰ independently represents a straight chain or cyclic alkylene group having 1 to 10 carbon atoms with the proviso that not all of R⁸, R⁹ and R¹⁰ are the same, x represents an integer of from 2 to 200, y represents an integer of from 2 to 100, and z represents an integer of from 0 to 200.

4. The coating composition according to item 3 above, wherein the organic block copolymer contains a structure of formula (3) with the proviso that R⁸ is the same as R⁹, and R¹⁰ is different from R⁸ and R⁹.

5. A method for producing a porous silica insulating thin film, which comprises the steps of:

(1) coating the composition of any one of items 1 to 4 above on a substrate to form a thin film of the composition on the substrate,

(2) subjecting the thin film to gelation with respect to the silica precursor (A) to thereby obtain a silica/organic polymer composite thin film, and

(3) removing the organic polymer (B) from the silica/organic polymer composite thin film to thereby obtain a porous silica insulating thin film.

6. A porous silica insulating thin film obtained by the method of item 5 above.

7. The porous silica insulating thin film according to item 6 above, which has a group represented by the following formula (4):

—Si—(R)ₚ—Si— (4)

wherein R represents an oxygen atom or a group —(CH₂)ᵣ— in which r represents an integer of from 1 to 6, and p represents 0 or 1,

wherein the difference between the skeletal density of the porous silica insulating thin film and the apparent density of the porous silica insulating thin film is 0.2 or more,

wherein the thickness of the porous silica insulating thin film is 100 μm or less.

8. The porous silica insulating thin film according to item 6 or 7 above, exhibiting a weight decrease ratio of 1% by weight or less as measured by thermogravimetric analysis (TGA) under conditions wherein the temperature of the porous silica insulating thin film is elevated at a rate of 10° C./min from room temperature to 425° C. and is maintained at 425° C. for 60 minutes.

9. An insulating laminate structure comprising an inorganic insulating layer comprised of the porous silica insulating thin film of any one of items 6 to 8 above and an organic insulating layer comprised of an organic compound.

10. A multilevel interconnect comprising a plurality of insulating layers and circuits formed on the insulating layers, wherein at least one layer of the insulating layers is comprised of the porous silica insulating thin film of any one of items 6 to 8 above.

11. A semiconductor device comprising the multilevel interconnect of item 10 above.

12. A multilevel interconnect comprising a plurality of insulating layers and circuits formed on the insulating layers, wherein at least one layer of the insulating layers is comprised of the insulating laminate structure of item 9 above.

13. A semiconductor device comprising the multilevel interconnect of item 11 above.

14. A coating composition for use in producing an insulating thin film, comprising:

(A) a silica precursor comprising at least one member selected from the group consisting of an alkoxysilane (a), an alkoxysilane (b), and hydrolysis/polycondensation products formed by hydrolysis/polycondensation reactions of the alkoxysilanes (a) and (b) under acidic conditions,

wherein:

the alkoxysilane (a) is represented by the following formula (1):

R¹ₙSi(OR²)₄₋ₙ (1)

wherein each R¹ independently represents a hydrogen atom, a straight chain or branched alkyl group having 1 to 6 carbon atoms, a vinyl group or a phenyl group, each R² independently represents a straight chain or branched alkyl group having 1 to 6 carbon atoms and n represents an integer of from 0 to 3, and

the alkoxysilane (b) is represented by the following formula (2):

R³ₘ(R⁴O)₃₋ₘSi—(R⁷)ₚ—Si(OR⁵)_{3-q}R⁶_{q} (2)

wherein each R³ independently represents a hydrogen atom, a straight chain or branched alkyl group having 1 to 6 carbon atoms, a vinyl group or a phenyl group, each R⁴ independently represents a straight chain or branched alkyl group having 1 to 6 carbon atoms, each R⁵ independently represents a straight chain or branched alkyl group having 1 to 6 carbon atoms, each R⁶ independently represents a hydrogen atom, a straight chain or branched alkyl group having 1 to 6 carbon atoms, a vinyl group or a phenyl group, R⁷ represents an oxygen atom, a phenylene group, or a group —(CH₂)ᵣ— in which r represents an integer of from 1 to 6, each of m and q independently represents an integer of from 0 to 2, and p represents 0 or 1; and

(B) an organic polymer containing 20% by weight or more, based on the weight of the organic polymer, of a straight chain or branched organic block copolymer;

(C) an acid having an electrolytic dissociation exponent (pKa) of from 1 to 11; and

(D) a quaternary ammonium salt,

wherein the coating composition has a pH value of less than 7.

15. The coating composition according to item 14 above, wherein the hydrolysis/polycondensation reactions for obtaining the silica precursor (A) are performed in the presence of the organic copolymer (B).

16. The coating composition according to item 14 or 15 above, wherein the organic block copolymer has at least one terminal group which is inert to the silica precursor (A).

17. The coating composition according to any one of items 14 to 16 above, wherein the organic block copolymer contains a structure represented by the following formula (3):

—(R⁸O)ₓ—(R¹⁰O)_{y}—(R⁹O)_{z} (3)

wherein each of R⁸, R⁹ and R¹⁰ independently represents a straight chain or cyclic alkylene group having 1 to 10 carbon atoms with the proviso that not all of R⁸, R⁹ and R¹⁰ are the same, x represents an integer of from 2 to 200, y represents an integer of from 2 to 100, and z represents an integer of from 0 to 200.

18. The coating composition according to item 17 above, wherein the organic block copolymer contains a structure of formula (3) with the proviso that R⁸ is the same as R⁹, and R¹⁰ is different from R⁸ and R⁹.

19. A method for producing a porous silica insulating thin film, which comprises the steps of:

(1) coating the composition of any one of items 14 to 18 above on a substrate to form a thin film of the composition on the substrate,

(2) subjecting the thin film to gelation with respect to the silica precursor (A) to thereby obtain a silica/organic polymer composite thin film, and

(3) removing the organic polymer (B) from the silica/organic polymer composite thin film to thereby obtain a porous silica insulating thin film.

20. A porous silica insulating thin film obtained by the method of item 19 above.

21. The porous silica insulating thin film according to item 20 above, which has a group represented by the following formula (4):

—Si—(R)ₚ—Si— (4)

wherein R represents an oxygen atom or a group —(CH₂)ᵣ— in which r represents an integer of from 1 to 6, and p represents 0 or 1,

wherein the difference between the skeletal density of the porous silica insulating thin film and the apparent density of the porous silica insulating thin film is 0.2 or more,

wherein the thickness of the porous silica insulating thin film is 100 μm or less.

22. The porous silica insulating thin film according to item 20 or 21 above, exhibiting a weight decrease ratio of 1% by weight or less as measured by thermogravimetric analysis (TGA) under conditions wherein the temperature of the porous silica insulating thin film is elevated at a rate of 10° C./min from room temperature to 425° C. and is maintained at 425° C. for 60 minutes.

23. An insulating laminate structure comprising an inorganic insulating layer comprised of the porous silica insulating thin film of any one of items 20 to 22 above and an organic insulating layer comprised of an organic compound.

24. A multilevel interconnect comprising a plurality of insulating layers and circuits formed on the insulating layers, wherein at least one layer of the insulating layers is comprised of the porous silica insulating thin film of any one of items 20 to 22 above.

25. A semiconductor device comprising the multilevel interconnect of item 24 above.

26. A multilevel interconnect comprising a plurality of insulating layers and circuits formed on the insulating layers, wherein at least one layer of the insulating layers is comprised of the insulating laminate structure of item 23 above.

27. A semiconductor device comprising the multilevel interconnect of item 26 above.

Hereinbelow, the present invention is described in detail.

First, with respect to the silica precursor (A) used in the present invention, an explanation is made below.

The silica precursor (A) comprises at least one member selected from the group consisting of an alkoxysilane (a), an alkoxysilane (b), and hydrolysis/polycondensation products formed by hydrolysis/polycondensation reactions of the alkoxysilanes (a) and (b) under acidic conditions,

wherein:

the alkoxysilane (a) is represented by the following formula (1):

R¹ₙSi(OR²)₄₋ₙ (1)

wherein each R¹ independently represents a hydrogen atom, a straight chain or branched alkyl group having 1 to 6 carbon atoms, a vinyl group or a phenyl group, each R² independently represents a straight chain or branched alkyl group having 1 to 6 carbon atoms and n represents an integer of from 0 to 3, and

the alkoxysilane (b) is represented by the following formula (2):

R³ₘ(R⁴O)₃₋ₘSi—(R⁷)ₚ—Si(OR⁵)_{3-q}R⁶_{q} (2)

wherein each R³ independently represents a hydrogen atom, a straight chain or branched alkyl group having 1 to 6 carbon atoms, a vinyl group or a phenyl group, each R⁴ independently represents a straight chain or branched alkyl group having 1 to 6 carbon atoms, each R⁵ independently represents a straight chain or branched alkyl group having 1 to 6 carbon atoms, each R⁶ independently represents a hydrogen atom, a straight chain or branched alkyl group having 1 to 6 carbon atoms, a vinyl group or a phenyl group, R⁷ represents an oxygen atom, a phenylene group, or a group —(CH₂)ᵣ— in which r represents an integer of from 1 to 6, each of m and q independently represents an integer of from 0 to 2, and p represents 0 or 1.

With respect to the alkoxysilane (a) (i.e., alkoxysilane represented by the formula (1) above), an explanation is made below. The alkoxysilane represented by the formula (1) wherein n is 0, that is, the alkoxysilane represented by the formula: Si(OR²)₄ is referred to as a tetrafunctional alkoxysilane. The alkoxysilane represented by the formula (1) wherein n is 1, that is, the alkoxysilane represented by the formula: R¹Si(OR²)₃ is referred to as a trifunctional alkoxysilane. The alkoxysilane represented by the formula (1) wherein n is 2, that is, the alkoxysilane represented by the formula: R¹₂Si(OR²)₂ is referred to as a bifunctional alkoxysilane. The alkoxysilane represented by the formula (1) wherein n is 3, that is, the alkoxysilane represented by the formula: R¹₃Si(OR²) is referred to as a monofunctional alkoxysilane.

With respect to the alkoxysilane (b) (i.e., alkoxysilane represented by the formula (2) above), an explanation is made below. When the sum (i.e., 6-m-q) of the number of R⁴O and the number of OR⁵ in the formula (2) is k, the alkoxysilane represented by the formula (2) is referred to as a k-functional alkoxysilane. For example, the alkoxysilane represented by the formula (2) wherein m=q=1, that is, the alkoxysilane represented by the formula: R³(R⁴O)₂Si—(R⁷)ₚ—Si(OR⁵)₂R⁶, is a tetrafunctional alkoxysilane. The alkoxysilane represented by the formula (2) wherein m=0 and q=1, that is, the alkoxysilane represented by the formula: (R⁴O )₃Si—(R⁷)ₚ—Si(OR⁵)₂R⁶, is a pentafunctional alkoxysilane. The alkoxysilane represented by the formula (2) wherein m=1 and q=0 is also a pentafunctional alkoxysilane. The alkoxysilane represented by the formula (2) wherein m=q=0, that is, the alkoxysilane represented by the formula: (R⁴O )₃Si—(R⁷)ₚ—Si(OR⁵)₃, is a hexafunctional alkoxysilane. The alkoxysilane represented by the formula (2) wherein m=q=2, that is, the alkoxysilane represented by the formula: R³₂(R⁴O)Si—(R⁷)ₚ—Si(OR⁵)R⁶₂, is a bifunctional alkoxysilane. The alkoxysilane represented by the formula (2) wherein m=2 and q=1, that is, the alkoxysilane represented by the formula: R³₂(R⁴O)Si—(R⁷)ₚ—Si(OR⁵)₂R⁶, is a trifunctional alkoxysilane. The alkoxysilane represented by the formula (2) wherein m=1 and q=2 is also a trifunctional alkoxysilane.

In the present invention, the term “silica” means a hydrolysis/polycondensation product formed by hydrolysis/polycondensation reactions of an alkoxysilane, wherein the product has a condensation ratio of more than 90%.

As mentioned above, the alkoxysilane represented by the formula (1), and a hydrolysis/polycondensation product formed by hydrolysis/polycondensation reactions of the alkoxysilane under acidic conditions can be used in the silica precursor (A). The alkoxysilane represented by the formula (1), which can be used as a starting material for producing the coating composition of the present invention, has a functionality of 4, 3, 2 or 1.

Specific examples of alkoxysilanes which are represented by the formula (1) and have a tetrafunctionality include tetramethoxysilane, tetraethoxysilane, tetra-n-propoxysilane, tetraisopropoxysilane, tetra-n-butoxysilane, tetra-sec-butoxysilane and tetra-tert-butoxysilane.

Specific examples of alkoxysilanes which are represented by the formula (1) and have a trifunctionality include trimethoxysilane, triethoxysilane, methyltrimethoxysilane, methyltriethoxysilane, ethyltrimethoxysilane, ethyltriethoxysilane, propyltrimethoxysilane, propyltriethoxysilane, isobutyltriethoxysilane, cyclohexyltrimethoxysilane, phenyltrimethoxysilane, phenyltriethoxysilane, vinyltrimethoxysilane, vinyltriethoxysilane, allyltrimethoxysilane, allyltriethoxysilane, methyltri-n-propoxysilane, methyltriisopropoxysilane, methyltri-n-butoxysilane, methyltri-sec-butoxysilane, methyltri-tert-butoxysilane, ethyltri-n-propoxysilane, ethyltriisopropoxysilane, ethyltri-n-butoxysilane, ethyltri-sec-butoxysilane, ethyltri-tert-butoxysilane, n-propyltri-n-propoxysilane, n-propyltriisopropoxysilane, n-propyltri-n-butoxysilane, n-propyltri-sec-butoxysilane, n-propyltri-tert-butoxysilane, isopropyltrimethoxysilane, isopropyltriethoxysilane, isopropyltri-n-propoxysilane, isopropyltriisopropoxysilane, isopropyltri-n-butoxysilane, isopropyltri-sec-butoxysilane, isopropyltri-tert-butoxysilane, n-butyltrimethoxysilane, n-butyltriethoxysilane, n-butyltri-n-propoxysilane, n-butyltriisopropoxysilane, n-butyltri-n-butoxysilane, n-butyltri-sec-butoxysilane, n-butyltri-tert-butoxysilane, n-butyltriphenoxysilane, sec-butyltrimethoxysilane, sec-butyltri-n-propoxysilane, sec-butyltriisopropoxysilane, sec-butyltri-n-butoxysilane, sec-butyltri-sec-butoxysilane, sec-butyltri-tert-butoxysilane, tert-butyltrimethoxysilane, tert-butyltriethoxysilane, tert-butyltri-n-propoxysilane, tert-butyltriisopropoxysilane, tert-butyltri-n-butoxysilane, tert-butyltri-sec-butoxysilane, tert-butyltri-tert-butoxysilane, phenyltri-n-propoxysilane, phenyltriisopropoxysilane, phenyltri-n-butoxysilane, phenyltri-sec-butoxysilane and phenyltri-tert-butoxysilane.

The hydrolysis product of the alkoxysilane may be a partial hydrolysis product of the alkoxysilane.

Of the above-mentioned alkoxysilanes having functionalities of three and four, especially preferred are tetramethoxysilane, tetraethoxysilane, trimethoxysilane, triethoxysilane, methyltrimethoxysilane, methyltriethoxysilane, dimethyldimethoxysilane and dimethyldiethoxysilane.

As examples of alkoxysilanes which are represented by the formula (1) above and have a bifunctionality, there can be mentioned alkoxysilanes having, bonded directly to the silicon atom thereof, two groups selected from the group consisting of an alkyl group and an aryl group. Specific examples of such alkoxysilanes include dimethyldimethoxysilane, dimethyldiethoxysilane, dimethyldi-n-propoxysilane, dimethyldiisopropoxysilane, dimethyldi-n-butoxysilane, dimethyldi-sec-butoxysilane, dimethyldi-tert-butoxysilane, diethyldimethoxysilane, diethyldiethoxysilane, diethyldi-n-propoxysilane, diethyldiisopropoxysilane, diethyldi-n-butoxysilane, diethyldi-sec-butoxysilane, diethyldi-tert-butoxysilane, diphenyldimethoxysilane, diphenyldiethoxysilane, diphenyldi-n-propoxysilane, diphenyldiisopropoxysilane, diphenyldi-n-butoxysilane, diphenyldi-sec-butoxysilane, diphenyldi-tert-butoxysilane, methylethyldimethoxysilane, methylethyldiethoxysilane, methylethyldi-n-propoxysilane, methylethyldiisopropoxysilane, methylethyldi-n-butoxysilane, methylethyldi-sec-butoxysilane, methylethyldi-tert-butoxysilane, methylpropyldimethoxysilane, methylpropyldiethoxysilane, methylpropyldi-n-propoxysilane, methylpropyldiisopropoxysilane, methylpropyldi-n-butoxysilane, methylpropyldi-sec-butoxysilane, methylpropyldi-tert-butoxysilane, methylphenyldimethoxysilane, methylphenyldiethoxysilane, methylphenyldi-n-propoxysilane, methylphenyldiiso-propoxysilane, methylphenyldi-n-butoxysilane, methylphenyldi-sec-butoxysilane, methylphenyldi-tert-butoxysilane, ethylphenyldimethoxysilane, ethylphenyldiethoxysilane, ethylphenyldi-n-propoxysilane, ethylphenyldiisopropoxysilane, ethylphenyldi-n-butoxysilane, ethylphenyldi-sec-butoxysilane and ethylphenyldi-tert-butoxysilane.

As further examples of alkoxysilanes which are represented by the formula (1) above and have a bifunctionality, there can be mentioned alkoxysilanes having, bonded directly to the silicon atom thereof, one or two vinyl groups. Specific examples of such alkoxysilanes include methylvinyldimethoxysilane, methylvinyldiethoxysilane, methylvinyldi-n-propoxysilane, methylvinyldiisopropoxysilane, methylvinyldi-n-butoxysilane, methylvinyldi-sec-butoxysilane, methylvinyldi-tert-butoxysilane, divinyldimethoxysilane, divinyldiethoxysilane, divinyldi-n-propoxysilane, divinyldiisopropoxysilane, divinyldi-n-butoxysilane, divinyldi-sec-butoxysilane and divinyldi-tert-butoxysilane.

Specific examples of alkoxysilanes which are represented by the formula (1) above and have a monofunctionality include trimethylmethoxysilane, trimethylethoxysilane, trimethyl-n-propoxysilane, trimethylisopropoxysilane, trimethyl-n-butoxysilane, trimethyl-sec-butoxysilane, trimethyl-tert-butoxysilane, triethylmethoxysilane, triethylethoxysilane, triethyl-n-propoxysilane, triethylisopropoxysilane, triethyl-n-butoxysilane, triethyl-sec-butoxysilane, triethyl-tert-butoxysilane, tripropylmethoxysilane, tripropylethoxysilane, tripropyl-n-propoxysilane, tripropylisopropoxysilane, tripropyl-n-butoxysilane, tripropyl-sec-butoxysilane, tripropyl-tert-butoxysilane, triphenylmethoxysilane, triphenylethoxysilane, triphenyl-n-propoxysilane, triphenylisopropoxysilane, triphenyl-n-butoxysilane, triphenyl-sec-butoxysilane, triphenyl-tert-butoxysilane, methyldiethylmethoxysilane, methyldiethylethoxysilane, methyldiethyl-n-propoxysilane, methyldiethylisopropoxysilane, methyldiethyl-n-butoxysilane, methyldiethyl-sec-butoxysilane, methyldiethyl-tert-butoxysilane, methyldipropylmethoxysilane, methyldipropylethoxysilane, methyldipropyl-n-propoxysilane, methyldipropylisopropoxysilane, methyldipropyl-n-butoxysilane, methyldipropyl(sec-butoxy)silane, methyldipropyl-tert-butoxysilane, methyldiphenylmethoxysilane, methyldiphenylethoxysilane, methyldiphenyl-n-propoxysilane, methyldiphenylisopropoxysilane, methyldiphenyl-n-butoxysilane, methyldiphenyl-sec-butoxysilane, methyldiphenyl-tert-butoxysilane, ethyldimethylmethoxysilane, ethyldimethylethoxysilane, ethyldimethyl-n-propoxysilane, ethyldimethylisopropoxysilane, ethyldimethyl-n-butoxysilane, ethyldimethyl-sec-butoxysilane, ethyldimethyl-tert-butoxysilane, ethyldipropylmethoxysilane, ethyldipropylethoxysilane, ethyldipropyl-n-propoxysilane, ethyldipropylisopropoxysilane, ethyldipropyl-n-butoxysilane, ethyldipropyl-sec-butoxysilane, ethyldipropyl-tert-butoxysilane, ethyldiphenylmethoxysilane, ethyldiphenylethoxysilane, ethyldiphenyl-n-propoxysilane, ethyldiphenylisopropoxysilane, ethyldiphenyl-n-butoxysilane, ethyldiphenyl-sec-butoxysilane, ethyldiphenyl-tert-butoxysilane, propyldimethylmethoxysilane, propyldimethylethoxysilane, propyldimethyl(n-propoxy)silane, propyldimethylisopropoxysilane, propyldimethyl-n-butoxysilane, propyldimethyl-sec-butoxysilane, propyldimethyl-tert-butoxysilane, propyldiethylmethoxysilane, propyldiethylethoxysilane, propyldiethyl-n-propoxysilane, propyldiethylisopropoxysilane, propyldiethyl-n-butoxysilane, propyldiethyl-sec-butoxysilane, propyldiethyl-tert-butoxysilane, propyldiphenylmethoxysilane, propyldiphenylethoxysilane, propyldiphenyl-n-propoxysilane, propyldiphenylisopropoxysilane, propyldiphenyl-n-butoxysilane, propyldiphenyl-sec-butoxysilane, propyldiphenyl-tert-butoxysilane, phenyldimethylmethoxysilane, phenyldimethylethoxysilane, phenyldimethyl-n-propoxysilane, phenyldimethylisopropoxysilane, phenyldimethyl-n-butoxysilane, phenyldimethyl-sec-butoxysilane, phenyldimethyl-tert-butoxysilane, phenyldiethylmethoxysilane, phenyldiethylethoxysilane, phenyldiethyl-n-propoxysilane, phenyldiethylisopropoxysilane, phenyldiethyl-n-butoxysilane, phenyldiethyl-sec-butoxysilane, phenyldiethyl-tert-butoxysilane, phenyldipropylmethoxysilane, phenyldipropylethoxysilane, phenyldipropyl-n-propoxysilane, phenyldipropylisopropoxysilane, phenyldipropyl-n-butoxysilane, phenyldipropyl-sec-butoxysilane and phenyldipropyl-tert-butoxysilane.

As further examples of alkoxysilanes which are represented by the formula (1) above and have a monofunctionality, there can be mentioned alkoxysilanes having, bonded directly to the silicon atom thereof, one to three vinyl groups. Specific examples of such alkoxysilanes include trivinylmethoxysilane, trivinylethoxysilane, trivinyl-n-propoxysilane, trivinylisopropoxysilane, trivinyl-n-butoxysilane, trivinyl-sec-butoxysilane, trivinyl-tert-butoxysilane, vinyldimethylmethoxysilane, vinyldimethylethoxysilane, vinyldimethyl-n-propoxysilane, vinyldimethylisopropoxysilane, vinyldimethyl-n-butoxysilane, vinyldimethyl-sec-butoxysilane, vinyldimethyl-tert-butoxysilane, vinyldiethylmethoxysilane, vinyldiethylethoxysilane, vinyldiethyl-n-propoxysilane, vinyldiethylisopropoxysilane, vinyldiethyl-n-butoxysilane, vinyldiethyl-sec-butoxysilane, vinyldiethyl-tert-butoxysilane, vinyldipropylmethoxysilane, vinyldipropylethoxysilane, vinyldipropyl-n-propoxysilane, vinyldipropylisopropoxysilane, vinyldipropyl-n-butoxysilane, vinyldipropyl-sec-butoxysilane and vinyldipropyl-tert-butoxysilane.

Of the above-mentioned alkoxysilanes which are represented by the formula (1) above and have functionalities of one and two, especially preferred are trimethylmethoxysilane, trimethylethoxysilane, triethylmethoxysilane, triethylethoxysilane, tripropylmethoxysilane, tripropylethoxysilane, triphenylmethoxysilane, triphenylethoxysilane, phenyldimethylmethoxysilane, phenyldimethylethoxysilane, diphenylmethylmethoxysilane, diphenylmethylethoxysilane, dimethyldiethoxysilane, diethyldiethoxysilane, diphenyldiethoxysilane, methylethyldiethoxysilane, methylphenyldiethoxysilane, ethylphenyldiethoxysilane, dimethyldimethoxysilane, diethyldimethoxysilane, diphenyldimethoxysilane, methylethyldimethoxysilane, methylphenyldimethoxysilane and ethylphenyldimethoxysilane.

As further examples of alkoxysilanes which are represented by the formula (1) above and have a bifunctionality, there can be mentioned an alkoxysilane having, bonded directly to the silicon atom thereof, one hydrogen atom. Specific examples of such alkoxysilanes include methyldimethoxysilane, methyldiethoxysilane, ethyldimethoxysilane, ethyldiethoxysilane, propyldimethoxysilane, propyldiethoxysilane, phenyldimethoxysilane and phenyldiethoxysilane.

As mentioned above, the alkoxysilane represented by the formula (2), and a hydrolysis/polycondensation product formed by hydrolysis/polycondensation reactions of the alkoxysilane under acidic conditions can be used in the silica precursor (A). The alkoxysilane represented by the formula (2), which can be used as a starting material for producing the coating composition of the present invention, has a functionality of two to six.

With respect to the alkoxysilanes which are represented by the formula (2) above wherein p=1 and R⁷ is a phenylene group or a group represented by the formula: —(CH₂)ᵣ— and which have a functionality of two, four or six, specific examples thereof are enumerated below. With respect to the alkoxysilanes which have a functionality of six, specific examples thereof include

bis(trimethoxysilyl)methane, bis(triethoxysilyl)methane,

bis(triphenoxysilyl)methane, bis(trimethoxysilyl)ethane,

bis(triethoxysilyl)ethane, bis(triphenoxysilyl)ethane,

1,3-bis(trimethoxysilyl)propane,

1,3-bis(triethoxysilyl)propane,

1,3-bis(triphenoxysilyl)propane,

1,4-bis(trimethoxysilyl)benzene and

1,4-bis(triethoxysilyl)benzene.

With respect to the alkoxysilanes which have a functionality of four, specific examples thereof include

bis(dimethoxymethylsilyl)methane,

bis(diethoxymethylsilyl)methane,

bis(dimethoxyphenylsilyl)methane,

bis(diethoxyphenylsilyl)methane,

bis(dimethoxymethylsilyl)ethane,

bis(diethoxymethylsilyl)ethane,

bis(dimethoxyphenylsilyl)ethane,

bis(diethoxyphenylsilyl)ethane,

1,3-bis(dimethoxymethylsilyl)propane,

1,3-bis(diethoxymethylsilyl)propane,

1,3-bis(dimethoxyphenylsilyl)propane and

1,3-bis(diethoxyphenylsilyl)propane.

With respect to the alkoxysilanes which have a functionality of two, specific examples thereof include

bis(methoxydimethylsilyl)methane,

bis(ethoxydimethylsilyl)methane,

bis(methoxydiphenylsilyl)methane,

bis(ethoxydiphenylsilyl)methane,

bis(methoxydimethylsilyl)ethane,

bis(ethoxydimethylsilyl)ethane,

bis(methoxydiphenylsilyl)ethane,

bis(ethoxydiphenylsilyl)ethane,

1,3-bis(methoxydimethylsilyl)propane,

1,3-bis(ethoxydimethylsilyl)propane,

1,3-bis(methoxydiphenylsilyl)propane and

1,3-bis(ethoxydiphenylsilyl)propane.

With respect to the alkoxysilanes represented by the formula (2) above wherein p=1 and R⁷ is an oxygen atom, specific examples thereof are enumerated below. With respect to the alkoxysilanes which have a functionality of three to six, specific examples thereof include

hexamethoxydisiloxane, hexaethoxydisiloxane,

hexaphenoxydisiloxane,

1,1,1,3,3-pentamethoxy-3-methyldisiloxane,

1,1,1,3,3-pentaethoxy-3-methyldisiloxane,

1,1,1,3,3-pentamethoxy-3-phenyldisiloxane,

1,1,1,3,3-pentaethoxy-3-phenyldisiloxane,

1,1,3,3-tetramethoxy-1,3-dimethyldisiloxane,

1,1,3,3-tetraethoxy-1,3-dimethyldisiloxane,

1,1,3,3-tetramethoxy-1,3-diphenyldisiloxane,

1,1,3,3-tetraethoxy-1,3-diphenyldisiloxane,

1,1,3-trimethoxy-1,3,3-trimethyldisiloxane,

1,1,3-triethoxy-1,3,3-trimethyldisiloxane,

1,1,3-trimethoxy-1,3,3-triphenyldisiloxane,

1,1,3-triethoxy-1,3,3-triphenyldisiloxane,

1,3-dimethoxy-1,1,3,3-tetramethyldisiloxane,

1,3-diethoxy-1,1,3,3-tetramethyldisiloxane,

1,3-dimethoxy-1,1,3,3-tetraphenyldisiloxane and

1,3-diethoxy-1,1,3,3-tetraphenyldisiloxane. With respect to the alkoxysilanes which have a bifunctionality, specific examples thereof include 1,3-dimethoxy-1,1,3,3-tetramethyldisiloxane, 1,3-diethoxy-1,1,3,3-tetramethyldisiloxane, 1,3-dimethoxy-1,1,3,3-tetraphenyldisiloxane and 1,3-diethoxy-1,1,3,3-tetraphenyldisiloxane.

With respect to the alkoxysilanes which are represented by the formula (2) above wherein p=0 and which have a functionality of two to six, specific examples thereof are enumerated below. With respect to the alkoxysilanes which have a functionality of six, specific examples thereof include hexamethoxydisilane, hexaethoxydisilane and hexaphenoxydisilane. With respect to the alkoxysilanes which have a functionality of five, specific examples thereof include 1,1,1,2,2-pentamethoxy-2-methyldisilane, 1,1,1,2,2-pentaethoxy-2-methyldisilane, 1,1,1,2,2-pentamethoxy-2-phenyldisilane and 1,1,1,2,2-pentaethoxy-2-phenyldisilane. With respect to the alkoxysilane which has four functionalities, specific examples thereof include 1,1,2,2-tetramethoxy1,2-dimethyldisilane, 1,1,2,2-tetraethoxy-1,2-dimethyldisilane, 1,1,2,2-tetramethoxy-1,2-diphenyldisilane and 1,1,2,2-tetraethoxy-1,2-diphenyldisilane. With respect to the alkoxysilanes which have a functionality of three, specific examples thereof include 1,1,2-trimethoxy-1,2,2-trimethyldisilane, 1,1,2-triethoxy-1,2,2-trimethyldisilane, 1,1,2-trimethoxy-1,2,2-triphenyldisilane and 1,1,2-triethoxy1,2,2-triphenyldisilane. With respect to the alkoxysilanes which have a functionality of two, specific examples thereof include 1,2-dimethoxy-1,1,2,2-tetramethyldisilane, 1,2-diethoxy-1,1,2,2-tetramethyldisilane, 1,2-dimethoxy-1,1,2,2-tetraphenyldisilane and 1,2-diethoxy-1,1,2,2-tetraphenyldisilane.

Of the above-mentioned alkoxysilanes which are represented by the formula (2) above and have functionalities of two to six, preferred are those which have a functionality of three or five.

As the silica precursor (A), there can be mentioned at least one member selected from the group consisting of the above-exemplified alkoxysilanes, and hydrolysis/polycondensation products formed by hydrolysis/polycondensation reactions of the alkoxysilanes under acidic conditions.

In the silica precursor (A), with respect to the respective ratios of the alkoxysilane, a hydrolysis product of the alkoxysilane, and a polycondensation product of the hydrolysis product, there is no particular limitation so long as the polycondensation reaction has not advanced to too large an extent such that the amount of the polycondensation reaction product obtained by gelation of the alkoxysilane becomes more than 90% by weight, based on the weight of the silica precursor (A).

The hydrolysis product of the alkoxysilane may be a partial hydrolysis product of the alkoxysilane. For example, when an alkoxysilane having a tetrafunctionality (i.e., having four alkoxyl groups in a molecule thereof) is used in the silica precursor (A), it is not required that all alkoxyl groups in a molecule of the alkoxysilane be hydrolyzed. For example, only one alkoxyl group in a molecule of the alkoxysilane may be hydrolyzed. Alternatively, two or more alkoxyl groups in a molecule of the alkoxysilane may be hydrolyzed. Further, the hydrolysis product may contain both a molecule having only one alkoxyl group hydrolyzed and a molecule having two or more alkoxyl groups hydrolyzed.

In the present invention, the term “polycondensation product” of the alkoxysilane means that a silanol group in a molecule of the hydrolysis product of the alkoxysilane undergoes condensation to form an Si—O—Si linkage. It is not required that, by the polycondensation, all silanol groups in a molecule of the hydrolysis product of the alkoxysilane form Si—O—Si linkages. Only a part of silanol groups in a molecule of the hydrolysis product may form Si—O—Si linkages. The hydrolysis products may have different degrees of condensation, which may be present in a mixture thereof.

In the silica precursor (A) (which comprises at least one member selected from the group consisting of an alkoxysilane represented by the formula (1), an alkoxysilane represented by the formula (2), and hydrolysis/polycondensation products formed by hydrolysis/polycondensation reactions of the alkoxysilanes under acidic conditions), the amount of silicon atoms derived from alkoxysilanes having functionalities of one, two and three is preferably from 1 to 80 mol %, more preferably from 10 to 80 mol %, still more preferably from 20 to 70 mol %, based on the total molar amount of the silicon atoms derived from alkoxysilanes having functionalities of one, two, three, four, five and six.

When the amount of the silicon atoms derived from alkoxysilanes having functionalities of one, two and three is less than 1 mol %, a porous silica insulating thin film obtained using the coating composition does not have satisfactorily low relative dielectric constant. On the other hand, when the amount of the silicon atoms derived from alkoxysilanes having functionalities of one, two and three is more than 80 mol %, the mechanical strength of the thin film becomes disadvantageously low.

Of the above-exemplified alkoxysilanes having functionalities of one, two and three, preferred are those which have, bonded directly to the silicon atom thereof, three groups selected from the group consisting of an alkyl group and an aryl group, such as trimethylethoxysilane, triethylethoxysilane, tripropylethoxysilane, triphenylethoxysilane, phenyldimethylethoxysilane and diphenylmethylethoxysilane; those which have, bonded directly to the silicon atom thereof, two groups selected from the group consisting of an alkyl group and an aryl group, such as dimethyldiethoxysilane, diethyldiethoxysilane, diphenyldiethoxysilane, methylethyldiethoxysilane, methylphenyldiethoxysilane and ethylphenyldiethoxysilane; and those which have, bonded directly to the silicon atom thereof, one group selected from the group consisting of an alkyl group and an aryl group.

Further preferred examples of alkoxysilanes include those which have, bonded directly to the silicon atom thereof, a hydrogen atom, such as methyldiethoxysilane, dimethylvinylmethoxysilane and dimethylvinylethoxysilane.

Still further preferred examples of alkoxysilanes include bis(ethoxydimethylsilyl)methane,

bis(ethoxydiphenylsilyl)methane,

bis(ethoxydimethylsilyl)ethane,

bis(ethoxydiphenylsilyl)ethane,

1,3-bis(ethoxydimethylsilyl)propane,

1,3-bis(ethoxydiphenylsilyl)propane,

1,3-diethoxy-1,1,3,3-tetramethyldisiloxane,

1,3-diethoxy-1,1,3,3-tetraphenyldisiloxane,

1,2-diethoxy-1,1,2,2-tetramethyldisilane and

1,2-diethoxy-1,1,2,2-tetraphenyldisilane.

Of these alkoxysilanes, especially preferred are trimethylethoxysilane, triethylethoxysilane, tripropylethoxysilane, triphenylethoxysilane, phenyldimethylethoxysilane and diphenylmethylethoxysilane, dimethyldiethoxysilane, diethyldiethoxysilane, diphenyldiethoxysilane, methylethyldiethoxysilane, methylphenyldiethoxysilane and ethylphenyldiethoxysilane.

The amount of the silica precursor (A) in the coating composition of the present invention can be represented in terms of the below-mentioned silica precursor concentration.

As mentioned below, the desired silica precursor concentration of the coating composition varies depending on the thickness of the porous silica insulating thin film to be produced. However, from the viewpoint of achieving excellent storage stability, the silica precursor concentration is preferably from 2 to 30% by weight.

With respect to the organic polymer (B) used in the present invention, an explanation is made below.

The organic polymer (B) contains 20% by weight or more of a straight chain or branched organic block copolymer, based on the weight of the organic polymer (B).

With respect to the straight chain organic block copolymer, an explanation is made below. From the viewpoint of producing a porous silica insulating thin film by calcining the coating composition (the method for producing the porous silica insulating thin film is explained below in detail), it is preferred that the straight chain organic block copolymer has a low heat decomposition temperature and has a relatively good compatibility with the silica precursor (A) and silica. In view of this, it is preferred that the straight chain organic block copolymer contains a structure represented by the following formula (7):

—(R⁸O)ₓ—(R¹⁰O)_{y}—(R⁹O)_{z}— (7)

wherein each of R⁸, R⁹ and R¹⁰ independently represents a straight chain or cyclic alkylene group having 1 to 10 carbon atoms with the proviso that not all of R⁸, R⁹ and R¹⁰ are the same, x represents an integer of from 2 to 200, y represents an integer of from 2 to 100, and z represents an integer of from 0 to 200.

In the above description, the term “have a relatively good compatibility” means that the organic block copolymer has a relatively good affinity to the silica precursor (A) and silica. When the organic block copolymer has a relatively good affinity to the silica precursor (A) and silica, the phase separation between the silica precursor (A) and the organic block copolymer is appropriately controlled, so that a porous silica insulating thin film which is obtained by removing the organic block copolymer from the below-mentioned silica/organic polymer composite thin film does not have a pore having an extremely large or small diameter and, hence, has a uniform pore diameter, thereby enhancing the surface smoothness and mechanical strength of the porous silica insulating thin film.

In the formula (7) above, when z is 0, the organic block copolymer comprises two polymer blocks and is generally referred to as a “diblock copolymer”. On the other hand, in the formula (7) above, when z is not 0, the organic block copolymer comprises three polymer blocks and is generally referred to as a “triblock copolymer”.

In the formula (7), it is preferred that R⁸ and R⁹ are the same and R¹⁰ is different from R⁸ and R⁹.

Examples of straight chain organic block copolymers include polyether block copolymers, such as diblock copolymers (e.g., a polyethylene glycol polypropylene glycol and a polyethylene glycol polybutylene glycol) and triblock copolymers (e.g., a polyethylene glycol polypropylene glycol polyethylene glycol, a polypropylene glycol polyethylene glycol polypropylene glycol and a polyethylene glycol polybutylene glycol polyethylene glycol).

As mentioned above, in the formula (7), each of R⁸, R⁹ and R¹⁰ independently represents a straight chain or cyclic alkylene group having 1 to 10 carbon atoms. However, alkylene groups other than mentioned above can also be preferably used as R⁸, R⁹ and R¹⁰.

Specifically, as a preferred example of straight chain organic block copolymers, there can be mentioned one containing a structure represented by the formula (7) wherein at least one of R⁸, R⁹ and R¹⁰ is a straight chain alkylene group, such as —CH₂— (methylene group), —(CH₂)₂— (ethylene group), —(CH₂)₃— (trimethylene group), —(CH₂)₄— (tetramethylene group), . . . , or —(CH₂)₁₀— (decylmethylene group), and the other(s) is (are) a substituted alkylene group (such as —CH(CH₃)CH₂— (1-methylethylene group), —CH₂CH(CH₃)— (2-methylethylene group), —CH(CH₃)₂CH₂— (1,1-dimethylethylene group), or —CH(CH₃)CH(CH₃)— (1,2-dimethylethylene group)) which is obtained by replacing at least one hydrogen atom of a straight chain alkylene group by a straight chain alkyl group (e.g., a n-propyl group) or a branched alkyl group (e.g., an isobutyl group).

In such a straight chain organic block copolymer, when R⁸ is —CH₂—, the chain —(R⁸O)ₓ— means a polyethylene glycol chain; and when R⁹ is —CH(CH₃)CH₂— or —CH₂CH(CH₃)—, the chain (R⁹O)_{z}— means a polypropylene glycol chain.

Examples of such straight chain organic block copolymers include diblock copolymers, such as a poly(oxyethylene)-poly(oxy-1-ethylethylene), a poly(oxy-1-methylethylene)-poly(oxyethylethylene), and a poly(oxy-1-methylethylene)-poly(oxy-1-ethylethylene); and triblock copolymers, such as a poly(oxyethylene)-poly(oxy-1-ethylethylene)-poly(oxyethylene), a poly-(oxy1-methylethylene)-poly(oxyethylene)-poly(oxy-1-methylethylene), and a poly(oxy-1-methylethylene)-poly(oxy-1-ethylethylene)-poly(oxy-1-methylethylene), wherein these copolymers are named in accordance with a recommendation by the Macromolecular Nomenclature Commission of the International Union of Pure and Applied Chemistry (see “Koubunshi (polymers)” vol. 51, pages 269-279 (2002), published by the Society of Polymer Science, Japan). The above exemplification of straight chain organic block copolymers should not be construed as limiting the scope of the present invention.

Of the above-mentioned straight chain organic block copolymers, especially preferred are those which contain a structure represented by the formula (7) wherein R¹⁰ is —(CH₂)_{w}— in which w is an integer of from 3 to 10. In this case, the central chain —(R¹⁰O)_{y}— in the formula (7) (i.e., the chain —(O(CH₂)_{w})_{y}—) comprises recurring units of a straight chain alkyleneoxide group (i.e., —O(CH₂)_{w}—). Specific examples of such straight chain alkyleneoxide groups include —O(CH₂)₃— (trimethyleneoxide group), —O(CH₂)₄— (tetramethyleneoxide group), —O(CH₂)₅— (pentamethyleneoxide group), —O(CH₂)₆— (hexamethyleneoxide group), —O(CH₂)₇— (heptamethyleneoxide group), —O(CH₂)₈— (octamethyleneoxide group), and —O(CH₂)₁₀— (decylmethyleneoxide group).

Specific examples of such straight chain organic block copolymers include diblock copolymers, such as a poly(oxyethylene)-poly(oxytrimethylene), a poly(oxyethylene)-poly(oxytetramethylene), a poly(oxy-1methylethylene)-poly(oxytrimethylene), and a poly(oxy-1-ethylethylene)-poly(oxytrimethylene); and triblock copolymers, such as a poly(oxyethylene)-poly(oxytrimethylene)-poly(oxyethylene), a poly(oxyethylene)-poly(oxytetramethylene)-poly(oxyethylene), and a poly(oxy-1-methylethylene)-poly(oxytrimethylene)-poly(oxy-1-methylethylene). The above exemplification of straight chain organic block copolymers should not be construed as limiting the scope of the present invention.

With respect to the above-mentioned group —(CH₂)_{w}— as R¹⁰, the embodiment in which w is 4 is especially preferred. That is, it is especially preferred that the straight chain organic block copolymer contains a structure represented by the formula: —(OR⁸)ₓ—(O(CH₂)₄)_{y}— (OR⁹)_{z}—. The use of such a straight chain organic block copolymer is advantageous in that, in the below-mentioned laminate structure comprising an inorganic insulating layer comprised of a porous silica insulating thin film (which is obtained from the coating composition) and an organic insulating layer comprised of an organic compound, the adhesion between the inorganic insulating layer and the organic insulating layer is greatly improved.

Examples of such straight chain organic block copolymers include diblock copolymers, such as a poly(oxyethylene)-poly(oxytetramethylene) and a poly(oxy-1-methylethylene)-poly(oxytetramethylene); and triblock copolymers, such as a poly(oxyethylene)-poly(oxytetramethylene)-poly(oxyethylene) and a poly(oxy-1-methylethylene)-poly(oxytetramethylene)-poly(oxy-1-methylethylene).

It should be noted that x, y and z in the above-mentioned formula indicate the polymerization degree of each of the polymer blocks constituting the straight chain organic block copolymers. When the organic block copolymer is a diblock copolymer (that is, when z is 0), each of x and y is preferably from 5 to 90, more preferably from 5 to 75, still more preferably from 5 to 60.

In the present invention, it is especially preferred that the straight chain organic block copolymer is a triblock copolymer (that is, z is not 0). In this case, each of x, y and z is preferably from 5 to 90, more preferably from 5 to 75, still more preferably from 5 to 60. The use of such a triblock copolymer is advantageous not only in that the storage stability of the coating composition can be enhanced, but also in that the mechanical strength of a porous silica insulating thin film obtained from the coating composition is greatly improved.

In the present invention, as the straight chain organic block copolymer, there can also be used an aliphatic higher alcohol/alkyleneoxide block copolymer which is obtained by addition polymerizing an alkyleneoxide to an aliphatic higher alcohol. Specific examples of such block copolymers include a polyoxyethylene lauryl ether, a polyoxypropylene lauryl ether, a polyoxyethylene oleyl ether, a polyoxypropylene oleyl ether, a polyoxyethylene cetyl ether, a polyoxypropylene cetyl ether, a polyoxyethylene stearyl ether and a polyoxypropylene stearyl ether.

With respect to the branched organic block copolymer, an explanation is made below.

It is preferred that the branched organic block copolymer is stably dissolved in the coating composition and is not deposited even at a low temperature. Further, it is preferred that the branched organic block copolymer exhibits a low heat decomposition temperature during the production of a porous silica insulating thin film by calcining the coating composition (the method for producing the porous silica insulating thin film is explained below in detail). Illustratively stated, it is preferred that the branched organic block copolymer comprises at least three aliphatic ether block copolymer branches (each of which is a di- or more-block copolymer) and a central coupling agent residue having at least three bonding sites which are capable of forming a carbon-oxygen bond, wherein the at least three aliphatic ether block copolymer branches are, respectively, bonded to the at least three bonding sites of the central coupling agent residue.

It is preferred that each of the aliphatic ether block copolymer branches in the branched organic block copolymer contains a chemical structure which is the same as that of the formula (7) and that the total amount of the aliphatic ether block copolymer branches in the branched organic block copolymer is 60% by weight or more, based on the weight of the branched organic block copolymer.

As an example of such branched organic block copolymers, there can be mentioned a branched block copolymer having a structure such that the terminal hydroxyl groups of the above-mentioned straight chain organic block copolymer branches are bonded to at least three bonding sites of a central coupling agent residue (such as a residue of an alkane, alicyclic compound, aromatic compound or saccharide), wherein the at least three bonding sites are capable of forming a carbon-oxygen bond.

Examples of bonding sites which are capable of forming a carbon-oxygen bond include a bonding site which is capable of forming an ether linkage, a single bond between the carbon atom of a carbonyl group and another oxygen atom (such as an ester linkage, a carbonate linkage or a urethane linkage) or an aromatic carbon-oxygen bond (such as a carbon-oxygen bond contained in a phenoxy group). The central coupling agent residue may have a capability of forming a plurality of different types of carbon-oxygen bonds mentioned above.

Examples of central coupling agent residues having bonding sites which are capable of forming an ether linkage include a residue of a compound having at least three hydroxyl groups, such as a residue of glycerol, trimethylolpropane, pentaerythritol, dipentaerythritol, sorbitol, mannitol or xylitol. A branched organic block copolymer can be formed, for example, as follows. Propyleneoxide is addition-bonded (by addition polymerization) to each of the hydroxyl groups of a compound having at least three hydroxyl groups to thereby cause at least three polypropyleneoxides to be, respectively, bonded to the bonding sites of the central coupling agent residue obtained from the compound, followed by addition polymerization of ethyleneoxide to each terminal of the at least three polypropyleneoxides, thereby obtaining a branched organic block copolymer wherein at least three polypropyleneoxide/polyethyleneoxide block copolymer branches are, respectively, bonded to the at least three bonding sites of the central coupling agent residue.

Alternatively, a branched organic block copolymer can also be formed by performing dehydration reactions between the terminal hydroxyl groups of aliphatic ether block copolymers having terminal hydroxyl groups and the hydroxyl groups of a compound having at least three hydroxyl groups. Further, a branched organic block copolymer can also be formed by performing dehydration reactions between the hydroxyl groups of polymer chains of aliphatic higher alcohol/alkyleneoxide block copolymers and the hydroxyl groups of a compound having at least three hydroxyl groups.

Specific examples of branched organic block copolymers include a glycerol polyethylene glycol polypropylene glycol, an erythritol polyethylene glycol polypropylene glycol polyethylene glycol, a sorbitol polyethylene glycol polypropylene glycol polyethylene glycol, a glycerol polyethylene glycol stearic ester and an erythritol polyethylene glycol stearic ester.

Specific examples of polyhydric alcohols (from which a central coupling agent residue can be derived) other than mentioned above include 1,2,4-benzenetriol, pyrogallol, threitol, maltitol, arabitol, lactitol, adonitol, cellobiose, glucose, fructose, sucrose, lactose, mannose, galactose, erythrose, xylulose, allulose, ribose, sorbose, xylose, arabinose, isomaltose, dextrose and glucoheptose.

Examples of central coupling agent residues having bonding sites which are capable of forming an ester linkage include a residue of citric acid, malic acid, tartaric acid, gluconic acid, glucuronic acid, glucoheptonic acid, glucooctanic acid, saccharic acid, galactonic acid, galactaric acid, galacturonic acid, glyceric acid, hydroxysuccinic acid, and aromatic carboxylic acid (such as 1,2,3-benzenetricarboxylic acid, 1,2,4-benzenetricarboxylic acid, 1,3,5-benzenetricarboxylic acid or 1,2,4,5-benzenetetracarboxylic acid).

Further, as a central coupling agent residue, there can be used a residue of a polymer comprising monomer units having an OH group or a COOH group, which polymer has a polymerization degree of from 3 to 1,000. Specific examples of such polymers include homopolymers, such as a polyvinyl alcohol, a polyacrylic acid, a polymethacrylic acid, a polyhydroxyethyl methacrylate, a poly(p-hydroxymethyl)styrene and a polyphenol, and copolymers of monomers constituting these homopolymers.

In the above, the straight chain and branched organic block copolymers used in the organic polymer (B) have been explained in detail. It is preferred that the organic block copolymer has at least one terminal group which is inert to the silica precursor (A). Preferred examples of such inert terminal groups include an alkyl ether group, an alkyl ester group, an alkylamide group and an alkyl carbonate group, a urethane group, and a trialkylsilyl group-modified group.

The amount of the organic block copolymer in the organic polymer (B) (containing a component organic polymer other than the organic block copolymer) is 20% by weight or more, based on the weight of the organic polymer (B). By using, in the coating composition, the organic polymer (B) containing such an amount of the organic block copolymer, the mechanical strength of a porous silica insulating thin film obtained from the coating composition can be greatly improved. When the amount of the organic block copolymer in the organic polymer (B) is less than 20% by weight, the mechanical strength of the porous silica insulating thin film is unsatisfactory. The amount of the organic block copolymer in the organic polymer (B) is preferably 25% by weight or more, more preferably 30% by weight or more, based on the weight of the organic polymer (B).

It is preferred that the organic polymer (B) contains not only the above-mentioned organic block copolymer but also a component organic polymer other than the organic block copolymer and that the component organic polymer other than the organic block copolymer has at least one terminal group which is inert to the silica precursor (A). The use of such component organic polymer in combination with the organic block copolymer is advantageous in that the removal of the organic copolymer (B) from the below-mentioned silica/organic polymer composite thin film can be easily conducted.

With respect to the component organic copolymer (other than the organic block copolymer) having at least one terminal group which is inert to the silica precursor (A), an explanation is made below.

Preferred examples of inert terminal groups include an alkyl ether group, an alkyl ester group, an alkylamide group and an alkyl carbonate group, each of which is a straight chain, branched or cyclic group having 1 to 8 carbon atoms.

With respect to the main chain structure of the component organic polymer other than the organic block copolymer, there is no particular limitation. Specific examples of component organic polymers other than the organic block copolymer include polymers which mainly comprise a member selected from the group consisting of a polyether, a polyester, a polycarbonate, a polyanhydride, a polyamide, a polyurethane, a polyurea, a polyacrylic acid, a polyacrylate, a polymethacrylic acid, a polymethacrylate, a polyacrylamide, a polymethacrylamide, a polyacrylonitrile, polymethacrylonitrile, a polyolefin, a polydiene, a polyvinyl ether, a polyvinyl ketone, a polyvinylamide, a polyvinylamine, a polyvinyl ester, a polyvinyl alcohol, a polyvinyl halide, a polyvinylidene halide, a polystyrene, a polysiloxane, a polysulfide, a polysulfone, a polyimine, a polyimide, cellulose, and derivatives thereof.

Further, the component organic polymer other than the organic block copolymer may be either a copolymer comprised of a different combination of monomers used for forming the above-mentioned polymers, or a copolymer comprised of at least one of monomers used for forming the above-mentioned polymers and another monomer. These organic polymers can be used individually or in combination.

Among the above-mentioned component organic polymers other than the organic block copolymer, especially preferred are those which mainly comprise a member selected from the group consisting of an aliphatic polyether, an aliphatic polyester, an aliphatic polycarbonate and an aliphatic polyanhydride, since these polymers are burnt away from the below-mentioned silica/organic polymer composite thin film by calcination so that a porous silica thin film can be easily obtained.

The above-mentioned organic polymers can be used individually or in combination. The main chain of the component organic polymer other than the organic block copolymer may contain a polymer chain comprising recurring units other than mentioned above so long as the effects of the present invention are not impaired.

Examples of aliphatic polyethers include those which have a main chain comprising a polyalkylene glycol, such as a polyethylene glycol, a polypropylene glycol, a polyisobutylene glycol, a polytrimethylene glycol, a polytetramethylene glycol, a polypentamethylene glycol, a polyhexamethylene glycol, a polydioxolane or a polydioxepane, and which have at least one terminal group modified with an alkyl ether group, an alkyl ester group, an alkylamide group or an alkyl carbonate group, wherein each of the alkyl ether group, alkyl ester group, alkylamide group and alkyl carbonate group may be either directly linked to the recurring unit positioned at the terminal of the polymer, or indirectly linked to the recurring unit positioned at the terminal of the polymer through an organic group.

Examples of aliphatic polyethers which have a terminal group modified with an ether group include an aliphatic polyether having a main chain comprising the above-mentioned polyalkylene glycol, wherein at least one terminal of the polyalkylene glycol is modified with an ether, such as methyl ether, ethyl ether, propyl ether or glycidyl ether. Preferred specific examples of such aliphatic polyethers having a terminal group modified with an ether group include a polyethylene glycol monomethyl ether, a polyethylene glycol dimethyl ether, a polypropylene glycol dimethyl ether, a polyisobutylene glycol dimethyl ether, a polyethylene glycol diethyl ether, a polyethylene glycol monoethyl ether, a polyethylene glycol dibutyl ether, a polyethylene glycol monobutyl ether, a polyethylene glycol diglycidyl ether, a polyethylene polypropylene glycol dimethyl ether, a glycerol polyethylene glycol trimethyl ether, a pentaerythritol polyethylene glycol tetramethyl ether, a pentitol polyethylene glycol pentamethyl ether and a sorbitol polyethylene glycol hexamethyl ether.

Examples of aliphatic polyethers which have a terminal group modified with an ester group include an aliphatic polyether having a main chain comprising the above-mentioned polyalkylene glycol, wherein at least one terminal of the polyalkylene glycol is modified with an ester, such as an acetic ester, a propionic ester, an acrylic ester, a methacrylic ester, or a benzoic ester. It is also preferred that the terminal of the polyalkylene glycol is modified with a carboxymethyl ether, and a carboxyl group of the terminal which has been modified with a carboxymethyl ether is modified with an alkyl ester.

Specific preferred examples of such aliphatic polyethers having a terminal group modified with an ester group include a polyethylene glycol monoacetate, a polyethylene glycol diacetate, a polypropylene glycol monoacetate, a polypropylene glycol diacetate, a polyethylene glycol dibenzoate, a polyethylene glycol diacrylate, a polyethylene glycol monomethacrylate, a polyethylene glycol dimethacrylate, a polyethylene glycol biscarboxymethyl ether dimethyl ester, a polypropylene glycol biscarboxymethyl ether dimethyl ester, a glycerol polyethylene glycol triacetate, a pentaerythritol polyethylene glycol tetraacetate, a pentitol polyethylene glycol pentaacetate and a sorbitol polyethylene glycol hexaacetate.

Examples of aliphatic polyethers which have a terminal amide group include those which are obtained by a method comprising modifying at least one terminal of the above-mentioned polyalkylene glycol with a carboxymethyl ether, followed by amidation; and those which are obtained by a method comprising modifying at least one terminal of the above-mentioned polyalkylene glycol with a carboxymethyl ether and effecting amination of the resultant terminal hydroxyl group, followed by amidation.

Specific preferred examples of such aliphatic polyethers having a terminal group modified with an amide group include a polyethylene glycol bis(carboxymethyl ether dimethylamide), a polypropylene glycol bis(carboxymethyl ether dimethylamide), a polyethylene glycol bis(carboxymethyl ether diethylamide), a glycerol polyethylene glycol tri(carboxymethyl ether dimethylamide), a pentaerythritol polyethylene glycol tetra(carboxymethyl ether dimethylamide), a pentitol polyethylene glycol penta(carboxymethyl ether dimethylamide) and a sorbitol polyethylene glycol hexa(carboxymethyl ether dimethylamide).

Examples of aliphatic polyethers which have a terminal alkyl carbonate group include those which are obtained by bonding a formyl ester group to at least one terminal of the above-mentioned polyalkylene glycol. Specific examples of such aliphatic polyethers include a bismethoxycarbonyloxy polyethylene glycol, a bisethoxycarbonyloxy polyethylene glycol, a bisethoxycarbonyloxy polypropylene glycol and a bis(tert-butoxycarbonyloxy) polyethylene glycol.

Further, there can be used aliphatic polyethers which have a terminal group modified with a urethane group or a trialkylsilyl group. With respect to the modification with a trialkylsilyl group, especially preferred is a modification with a trimethylsilyl group. Such a modification can be conducted by using trimethylchlorosilane, trimethylchlorosilylacetamide, hexamethyldisilazane or the like.

Examples of aliphatic polyesters include polycondensation products of a hydroxycarboxylic acid, such as a polyglycolide; ring-opening polymerization reaction products of a lactone, such as a polycaprolactone and a polypivalolactone; polycondensation products of a dicarboxylic acid with an alkylene glycol, such as a polyethylene oxalate, a polyethylene succinate, a polyethylene adipate, a polyethylene sebacate, a polypropylene adipate and a polyoxydiethylene adipate; and ring-opening polymerization reaction products of an epoxide with an acid anhydride, wherein each of the above-mentioned polymers has at least one terminal thereof modified with an alkyl ether group, an alkyl ester group, an alkylamide group, an alkyl carbonate group, a urethane group or a trialkylsilyl group.

Examples of aliphatic polycarbonates include those which have a main chain comprising a polycarbonate, such as a polyethylene carbonate, a polypropylene carbonate, a polypentamethylene carbonate or a polyhexamethylene carbonate, wherein each of the above-mentioned polymers has at least one terminal thereof modified with an alkyl ether group, an alkyl ester group, an alkylamide group, an alkyl carbonate group, a urethane group or a trialkylsilyl group.

Examples of aliphatic polyanhydrides include those which have a main chain comprising a polycondensation product of a dicarboxylic acid, such as a polymalonyl oxide, a polyadipoyl oxide, a polypimeloyl oxide, a polysuberoyl oxide, a polyazelaoyl oxide or a polysebacoyl oxide, wherein each of the polymers has at least one terminal thereof modified with an alkyl ether group, an alkyl ester group, an alkylamide group, an alkyl carbonate group, a urethane group or a trialkylsilyl group.

In the present invention, the term “alkylene glycol” means a dihydric alcohol obtained by substituting an alkane having two or more carbon atoms with two hydroxyl groups so that two hydrogen atoms bonded to different carbon atoms in the alkanes are replaced by the hydroxyl groups. The term “dicarboxylic acid” means an organic acid having two carboxyl groups, such as oxalic acid, malonic acid, succinic acid, glutaric acid, adipic acid, pimelic acid, suberic acid, azelaic acid or sebacic acid.

In a preferred embodiment of the present invention, at least one terminal group of the organic block copolymer has a very good compatibility with the silica precursor (A). Since a branched polymer has more terminal groups than a straight chain one, it is preferred that the organic block copolymer is a branched one. In this case, the compatibility of the organic polymer (B) with the silica precursor (A) is improved, so that the below-mentioned silica/organic polymer composite thin film has an improved homogeneity. As a result, the surface smoothness of the silica/organic polymer composite thin film and porous silica insulating thin film is enhanced.

The above-mentioned polymer having at least one terminal group which has a very good compatibility with the silica precursor (A) may have a structure comprising at least three block copolymer branches and a saccharide, wherein the at least three block copolymer branches are bonded to different hydroxyl groups of the saccharide.

In the present invention, an organic polymer having at least one polymerizable functional group in a molecule thereof can be used in the organic polymer (B). The use of such an organic polymer is advantageous in that the mechanical strength of the porous silica insulating thin film is enhanced.

Examples of polymerizable functional groups include a vinyl group, a vinylidene group, a vinylene group, a glycidyl group, an allyl group, an acryloyl group, a methacryloyl group, an acrylamide group, a methacrylamide group, a carboxyl group, a hydroxyl group, an isocyanate group, an amino group, an imino group and a halogen atom-containing group. These polymerizable functional groups may be positioned in a main chain or side chain of the polymer or at a terminal of the polymer. Further, the polymerizable functional groups may be either directly linked to a polymer chain of the polymer, or indirectly linked to the polymer chain through a spacer, such as an alkylene group or an ether group. In the polymer, a single molecule thereof may have a single type of functional group or two or more different types of functional groups. Of the above-mentioned functional groups, preferred are a vinyl group, a vinylidene group, a vinylene group, a glycidyl group, an allyl group, an acryloyl group, a methacryloyl group, an acrylamide group and a methacrylamide group.

With respect to the main chain structure of the organic polymer having at least one polymerizable functional group in a molecule thereof, there is no particular limitation. Specific examples of organic polymers having at least one polymerizable functional group in a molecule thereof include polymers which mainly comprise a member selected from the group consisting of a polyether, a polyester, a polycarbonate, a polyanhydride, a polyamide, a polyurethane, a polyurea, a polyacrylic acid, a polyacrylate, a polymethacrylic acid, a polymethacrylate, a polyacrylamide, a polymethacrylamide, a polyacrylonitrile, polymethacrylonitrile, a polyolefin, a polydiene, a polyvinyl ether, a polyvinyl ketone, a polyvinylamide, a polyvinylamine, a polyvinyl ester, a polyvinyl alcohol, a polyvinyl halide, a polyvinylidene halide, a polystyrene, a polysiloxane, a polysulfide, a polysulfone, a polyimine, a polyimide, cellulose, and derivatives thereof. The organic polymer having at least one polymerizable functional group in a molecule thereof may be either a copolymer of different monomers used for forming the above-mentioned polymers, or a copolymer of at least one of monomers used for forming the above-mentioned polymers with another monomer. These organic polymers can be used individually or in combination.

Among the above-mentioned organic polymers, preferred are those which mainly comprise a member selected from the group consisting of a polyether, a polyester, a polycarbonate, a polyanhydride, a polyamide, a polyurethane, a polyurea, a polyacrylic acid, a polyacrylate, a polymethacrylic acid, a polymethacrylate, a polyacrylamide, a polymethacrylamide, a polyvinylamide, a polyvinylamine, a polyvinyl ester, a polyvinyl alcohol, a polyimine and a polyimide. Further, from the viewpoint of producing a porous silica insulating thin film by calcining the coating composition (the method for producing the porous silica insulating thin film is explained below in detail), it is especially preferred to use organic polymers which mainly comprise a member selected from the group consisting of an aliphatic polyether, an aliphatic polyester, an aliphatic polycarbonate and an aliphatic polyanhydride, each of which has low heat decomposition temperatures.

With respect to preferred organic polymers having at least one polymerizable functional group in a molecule thereof, specific examples of basic skeletons thereof are enumerated below (wherein in the following enumeration, the term “alkylene” means any one of “methylene”, “ethylene”, “propylene”, “trimethylene”, “tetramethylene”, “pentamethylene”, “hexamethylene”, “isopropylidene”, “1,2-dimethylethylene” and “2,2-dimethyltrimethylene”; the term “alkyl” means an alkyl group having 1 to 8 carbon atoms; the term “aryl” means, for example, a phenyl group, a tolyl group, an anisyl group or the like; the term “(meth)acrylate” means both an acrylate and a methacrylate; and the term “dicarboxylic acid” means an organic acid, such as oxalic acid, malonic acid, succinic acid, glutaric acid, adipic acid, pimelic acid, suberic acid, azelaic acid or sebacic acid):

(a) aliphatic polyethers having a polymerizable functional group (such as an acryloyl group, a methacryloyl group, a vinyl group or a glycidyl group) at their respective terminals, such as a polyalkylene glycol (meth)acrylate, a polyalkylene glycol di(meth)acrylate, a polyalkylene glycol alkyl ether (meth)acrylate, a polyalkylene glycol vinyl ether, a polyalkylene glycol divinyl ether, a polyalkylene glycol alkyl ether vinyl ether, a polyalkylene glycol glycidyl ether, a polyalkylene glycol diglycidyl ether and a polyalkylene glycol alkyl ether glycidyl ether;

(b) polycaprolactones having a polymerizable functional group (such as an acryloyl group, a methacryloyl group, a vinyl group or a glycidyl group) at their respective one or both terminals, such as a polycaprolactone (meth)acrylate, a polycaprolactone vinyl ether, a polycaprolactone glycidyl ether, a polycaprolactone vinyl ester, a polycaprolactone glycidyl ester, a polycaprolactone vinyl ester (meth)acrylate, a polycaprolactone glycidyl ester (meth)acrylate, a polycaprolactone vinyl ester vinyl ether, a polycaprolactone glycidyl ester vinyl ether, a polycaprolactone vinyl ester glycidyl ether and a polycaprolactone glycidyl ester glycidyl ether;

(c) (meth)acrylic esters, di(meth)acrylic esters, tri(meth)acrylic esters, vinyl ethers, divinyl ethers, trivinyl ethers, glycidyl ethers, diglycidyl ethers, and triglycidyl ethers of a polycaprolactone triol;

(d) aliphatic polyesters which are obtained by copolymerization of a dicarboxylic acid with an alkylene glycol and which have a polymerizable functional group (such as an acryloyl group, a methacryloyl group, a vinyl group or a glycidyl group) at their respective one or both terminals;

(e) aliphatic polyalkylene carbonates having a polymerizable functional group (such as an acryloyl group, a methacryloyl group, a vinyl group or a glycidyl group) at their respective one or both terminals;

(f) aliphatic polyanhydrides which are obtained by polymerization of a dicarboxylic anhydride and which have a polymerizable functional group (such as an acryloyl group, a methacryloyl group, a vinyl group or a glycidyl group) at their respective terminals;

(g) polyacrylates and polymethacrylates having a functional group (such as a vinyl group, a glycidyl group or an allyl group) in their respective side chains, such as a polyglycidyl (meth)acrylate, a polyallyl (meth)acrylate and a polyvinyl (meth)acrylate; and

(h) polyvinyl cinnamates, polyvinyl azido benzals, epoxy resins and the like.

Among the above-mentioned polymers, from the viewpoint of easy production of a porous silica insulating thin film by calcining the coating composition (the method for producing the porous silica insulating thin film is explained below in detail), especially preferred are an aliphatic polyether, an aliphatic polyester, an aliphatic polycarbonate and an aliphatic polyanhydride.

With respect to the molecular weight of the organic polymer (B), an explanation is made below. The number average molecular weight of the organic polymer (B) is generally from 100 to 1,000,000, preferably from 100 to 300,000, more preferably from 200 to 50,000.

When the number average molecular weight of the organic polymer (B) is smaller than 100, the organic polymer (B) is removed too fast from the below-mentioned silica/organic polymer composite thin film, so that it is likely that a porous silica insulating thin film having a desired high porosity cannot be obtained. On the other hand, the number average molecular weight of the organic polymer (B) is larger than 1,000,000, the organic polymer (B) is removed too slowly from the silica/organic polymer composite thin film, so that it is likely that the organic polymer (B) remains in the porous silica insulating thin film. When the number average molecular weight of the organic polymer (B) is in the above-mentioned more preferred range of from 200 to 50,000, a porous silica insulating thin film having a desired high porosity can be very easily obtained at a low temperature in a short period of time. In this connection, it should be noted that the pore size of the porous silica insulating thin film becomes very small and uniform without depending heavily on the number average molecular weight of the organic polymer (B).

With respect to the amount of the organic polymer (B) in the coating composition of the present invention, an explanation is made below (it should be noted that, when the organic polymer (B) contains, as component polymers thereof, not only the component organic block copolymer but also a component organic polymer other than the organic block copolymer, the amount of the organic polymer (B) means the total amount of the component polymers). In the present invention, the amount of the organic polymer (B) in the coating composition is preferably from 0.01 to 10 parts by weight, more preferably from 0.05 to 5 parts by weight, most preferably from 0.1 to 3 parts by weight, relative to 1 part by weight of the total of siloxanes formed by the hydrolysis/polycondensation reactions of the whole amount of the alkoxysilane(s) used as a starting raw material. When the amount of the organic polymer (B) is smaller than 0.01 part by weight, it is possible that the silica obtained does not become porous. On the other hand, when the amount of the organic polymer (B) is larger than 10 parts by weight, a porous silica thin film having a satisfactorily high mechanical strength cannot always be obtained. In the above description, the term “siloxanes formed by the hydrolysis/polycondensation reactions of the whole amount of the alkoxysilane(s) used as a starting raw material” means siloxanes obtained by completely hydrolyzing the alkoxysilanes represented by the formulae (1) and (2) to convert all the Si—OR² groups, Si—OR⁴ groups and Si—OR⁵ groups in the molecules of the alkoxysilane to Si—OH groups by 100% hydrolysis, and converting all the Si—OH groups to siloxane linkages (Si—O—Si) by 100% condensation.

In the present invention, an acid can be used as a catalyst for hydrolysis/polycondensation reactions of the alkoxysilane(s). By the use of the acid catalyst, not only can the hydrolysis/polycondensation reactions of the alkoxysilane(s) be accelerated, but also the molecular weight of the silica precursor (A) can be easily adjusted to a desired level. It is preferred that the weight average molecular weight of the silica precursor (A) is in the range of from 500 to 100,000.

When the weight average molecular weight of the silica precursor (A) is in the above-mentioned range, micells are formed between the silica precursor (A) and the organic block copolymer by the action of the organic block copolymer as a surfactant, so that the mechanical strength of a porous silica insulating thin film obtained from the coating composition is improved.

When a base catalyst is used, the molecular weight of the silica precursor (A) is likely to become extremely large as compared to the case of an acid catalyst, so that gelation of the silica precursor (A) is likely to occur during the production of the coating composition. As a result, the coating composition produced does not have a good ability to form a coating.

Specific examples of acids usable as a catalyst for hydrolysis/polycondensation reactions of the alkoxysilane(s) include inorganic acids, such as hydrochloric acid, nitric acid, sulfuric acid, hydrofluoric acid, tripolyphosphoric acid, phosphoric acid and phosphonic acid; and organic acids, such as formic acid, acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, mellitic acid, arachidonic acid, shikimic acid, 2-ethylhexanoic acid, oleic acid, stearic acid, linolic acid, linolenic acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, malonic acid, a sulfonic acid, phthalic acid, fumaric acid, citric acid, tartaric acid, succinic acid and isonicotinic acid.

Of these acid catalysts, preferred are those having an electrolytic dissociation exponent (pKa) of from 1 to 11. The use of such an acid catalyst is advantageous in that a porous silica insulating thin film having a greatly improved hydrophobicity and hence having a satisfactorily low relative dielectric constant can be obtained from the coating composition. In this connection, it should be noted that an acid having a pKa of larger than 11 generally has too poor a catalytic activity and, hence, is not suitable for practical use.

As mentioned above, in the present invention, acids having a pKa of from 1 to 11 are preferred. Examples of such acids include formic acid (pKa=3.6), acetic acid (pKa=4.6), propionic acid (pKa=4.7), butanoic acid (pKa=4.6), heptanoic acid (pKa=4.7), octanoic acid (pKa=4.9), salicylic acid (pKa=2.8), benzoic acid (pKa=4.2), lactic acid (pKa=3.7), oxalic acid (pKa=1.0), boric acid (pKa=9.2), nonanoic acid, decanoic acid and lauric acid.

However, it should be noted that, even an acid having a pKa outside the range of from 1 to 11 can be suitably used when the acid can be easily removed from the coating composition by filtration or the like. Preferred examples of such acid catalysts include cation exchange resins.

Examples of cation exchange resins include strong acid type cation exchange resins, such as a sulfonic acid type cation exchange resin; and weak acid type cation exchange resins, such as a carboxylic acid type cation exchange resin.

Specific examples of cation exchange resins include AMBERLITE IR120B, AMBERLITE A26, AMBERLITE MB2, AMBERLYST RCP-160M, AMBERLYST 15DRY and AMBERLYST 15WET (these AMBERLITE and AMBERLYST cation exchange resins are manufactured and sold by ORGANO CORP., U.S.A.); DIAION PK220, DIAION SK112, DIAION WK100 and DIAION PA412 (these DIAION cation exchange resins are manufactured and sold by Mitsubishi Chemical Corporation, Japan); DOWEX 50W-X2, DOWEX 50W-X4, DOWEX 50W-X6 and DOWEX 50W-X8 (these DOWEX cation exchange resins are manufactured and sold by Dow Chemical Company, U.S.A.).

The amount of the acid as a catalyst varies depending on the pKa thereof. However, the amount of the acid is generally 1 mol or less, preferably 0.1 mol or less, per mol of the total of the Si—OR² groups, Si—OR⁴ groups and Si—OR⁵ groups in the alkoxysilanes represented by the formulae (1) and (2) used as a starting raw material. When the amount of the acid is more than 1 mol, the catalytic activity of the acid is too strong, so that a deposit is likely to be formed, thereby rendering it difficult to obtain a uniform porous silica insulating thin film.

Two or more different acid catalysts can be stepwise used. Alternatively, two or more different acid catalysts can be simultaneously used. In the above description, the term “stepwise used” means that the hydrolysis/polycondensation reactions of the alkoxysilane(s) are performed in the presence of a catalyst, and then the hydrolysis/polycondensation reactions are further performed in the presence of another catalyst.

With respect to the quaternary ammonium salt used in the present invention, an explanation is made below. The use of the quaternary ammonium salt in a specific amount in the coating composition is advantageous in that a porous silica insulating thin film having excellent hydrophobicity and very low relative dielectric constant can be obtained from the coating composition.

The reason for this is presumed to be that silanol groups remaining in the thin film, which are hygroscopic and serve as a substance causing the relative dielectric constant of the thin film to be increased, are deactivated in the presence of the quaternary ammonium salt.

Specific examples of quaternary ammonium salts include tetramethylammonium hydroxide, tetraethylammonium hydroxide, tetra-n-propylammonium hydroxide, tetraisopropylammonium hydroxide, tetrahexylammonium hydroxide, trimethylmonoethanolammonium hydroxide, triethylmonoethanolammonium hydroxide and trimethylmonopropanolammonium hydroxide.

These quaternary ammonium salts can be used individually or in combination.

The amount of the quaternary ammonium salt is generally from 0.0001 to 0.1 part by weight, preferably from 0.001 to 0.05 part by weight, relative to 1,000 parts by weight of the total of siloxanes formed by the hydrolysis/polycondensation reactions of the whole amount of the alkoxysilane(s) used as a starting raw material. When the amount of the quaternary ammonium salt is less than 0.0001 part by weight, it is impossible to obtain a porous silica insulating thin film having a satisfactorily low relative dielectric constant by performing a low temperature curing (heating) of the coating composition for a short period of time. On the other hand, when the amount of the quaternary ammonium salt is more than 0.1 part by weight, it is also impossible to obtain a porous silica insulating thin film having a satisfactorily low relative dielectric constant.

However, it should be noted that when the quaternary ammonium salt is contained in the coating composition, a problem sometimes arises that the coating composition has very poor storage stability. Illustratively stated, the coating composition becomes solidified when the coating composition is just allowed to stand after the production thereof at room temperature for several days. The reason for this is presumed to be that when the coating composition contains a certain amount of the quaternary ammonium salt, which is a basic compound, the coating composition has a basic pH value, so that the rate of the polycondensation reaction of the alkoxysilane(s) becomes high.

The above-mentioned problem can be solved by incorporating an acid into the coating composition in an amount which is larger than the neutralization equivalent amount, so that the pH of the coating composition becomes less than 7, thereby greatly improving the storage stability of the coating composition. The coating composition of the present invention has a pH in the range of less than 7, which is one of the characteristic features of the coating composition. The pH of the coating composition is preferably 5 or less, more preferably from 3 to 5.

When the amount of the acid as a catalyst used in the hydrolysis/polycondensation reactions of the alkoxysilane(s) is insufficient to make the pH of the coating composition less than 7, the pH of the coating composition can be adjusted to a desired value of 7 or more by incorporating an additional acid into the coating composition.

The pKa of the additional acid is preferably from 1 to 11. The use of the additional acid having a pKa of from 1 to 11 is advantageous in that a porous silica insulating thin film exhibiting a greatly improved hydrophobicity and a satisfactorily low relative dielectric constant can be obtained from the coating composition. When the pKa of the additional acid is more than 11, the acidic property of the acid is unsatisfactory, so that the storage stability of the coating composition becomes poor. The pKa of the additional acid is more preferably from 3 to 6.

In the present invention, from the viewpoint of the storage stability and good ability to form a coating of the coating composition, it is preferred that an organic solvent is incorporated into the coating composition. When an organic solvent is used, the pH of the coating composition is measured with respect to the composition containing the organic solvent therein.

The organic solvent used in the present invention is at least one member selected from the group consisting of alcohols, ketones, amides and esters, wherein the coating composition is dispersed or dissolved in the organic solvent.

Examples of alcohols useful as solvents include monohydric alcohols, such as methanol, ethanol, n-propanol, isopropanol, n-butanol, isobutanol, sec-butanol, tert-butanol, n-pentanol, isopentanol, 2-methylbutanol, sec-pentanol, tert-pentanol, 3-methoxybutanol, n-hexanol, 2-methylpentanol, sec-hexanol, 2-ethylbutanol, sec-heptanol, heptanol-3, n-octanol, 2-ethylhexanol, sec-octanol, n-nonyl alcohol, 2,6-dimethylheptanol-4, n-decanol, sec-undecyl alcohol, trimethylnonyl alcohol, sec-tetradecyl alcohol, sec-heptadecyl alcohol, phenol, cyclohexanol, methylcyclohexanol, 3,3,5-trimethylcyclohexanol, benzyl alcohol and diacetone alcohol; polyhydric alcohols, such as ethylene glycol, 1,2-propylene glycol, 1,3-butylene glycol, pentanediol-2,4, 2-methylpentanediol-2,4, hexanediol-2,5, heptanediol-2,4, 2-ethylhexanediol-1,3, diethylene glycol, dipropylene glycol, triethylene glycol and tripropylene glycol; partially etherified polyhydric alcohols, such as ethylene glycol monomethyl ether, ethylene glycol monoethyl ether, ethylene glycol monopropyl ether, ethylene glycol monobutyl ether, ethylene glycol monohexyl ether, ethylene glycol monophenyl ether, ethylene glycol mono-2-ethylbutyl ether, diethylene glycol monomethyl ether, diethylene glycol monoethyl ether, diethylene glycol monopropyl ether, diethylene glycol monobutyl ether, diethylene glycol monohexyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether and dipropylene glycol monopropyl ether. These alcohols can be used individually or in combination.

Of these alcohols useful as solvents, preferred are n-propanol, isopropanol, n-butanol, isobutanol, sec-butanol, tert-butanol, n-pentanol, isopentanol, 2-methylbutanol, sec-pentanol, tert-pentanol, 3-methoxybutanol, n-hexanol, 2-methylpentanol, sec-hexanol, 2-ethylbutanol, ethylene glycol monomethyl ether, ethylene glycol monoethyl ether, ethylene glycol monopropyl ether, ethylene glycol monobutyl ether, ethylene glycol monohexyl ether, propylene glycol monomethyl ether, propylene glycol monoethyl ether, propylene glycol monopropyl ether, propylene glycol monobutyl ether and the like.

Examples of ketones useful as solvents include acetone, methyl ethyl ketone, methyl n-propyl ketone, methyl n-butyl ketone, diethyl ketone, methyl isobutyl ketone, methyl n-pentyl ketone, ethyl n-butyl ketone, methyl n-hexyl ketone, diisobutyl ketone, trimethylnonanone, cyclohexanone, 2-hexanone, methylcyclohexanone, 2,4-pentanedione, acetonylacetone, acetophenone and fenchone. Further examples of ketones useful as solvents include β-diketones such as acetylacetone, 2,4-hexanedione, 2,4-heptanedione, 3,5-heptanedione, 2,4-octanedione, 3,5-octanedione, 2,4-nonanedione, 3,5-nonanedione, 5-methyl-2,4-hexanedione, 2,2,6,6-tetramethyl-3,5-heptanedione and 1,1,1,5,5,5-hexafluoro-2,4-heptanedione. These ketones can be used individually or in combination.

Examples of amides useful as solvents include formamide, N-methylformamide, N,N-dimethylformamide, N-ethylformamide, N,N-diethylformamide, acetamide, N-methylacetamide, N,N-dimethylacetamide, N-ethylacetamide, N,N-diethylacetamide, N-methylpropioneamide, N-methylpyrrolidone, N-formylmorpholine, N-formylpiperidine, N-formylpyrrolidine, N-acetylmorpholine, N-acetylpiperidine and N-acetylpyrrolidine. These amides can be used individually or in combination.

Examples of esters useful as solvents include diethyl carbonate, ethylene carbonate, propylene carbonate, methyl acetate, ethyl acetate, γ-butyrolactone, γ-valerolactone, n-propyl acetate, isopropyl acetate, n-butyl acetate, isobutyl acetate, sec-butyl acetate, n-pentyl acetate, sec-pentyl acetate, 3-methoxybutyl acetate, methylpentyl acetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, ethylene glycol monomethyl ether acetate, ethylene glycol monoethyl ether acetate, diethylene glycol monomethyl ether acetate, diethylene glycol monoethyl ether acetate, diethylene glycol mono-n-butyl ether acetate, propylene glycol monomethyl ether acetate, propylene glycol monoethyl ether acetate, propylene glycol monopropyl ether acetate, propylene glycol monobutyl ether acetate, dipropylene glycol monomethyl ether acetate, dipropylene glycol monoethyl ether acetate, glycol diacetate, methoxy triglycol acetate, ethyl propionate, n-butyl propionate, isoamyl propionate, di-ethyl oxalate, di-n-butyl oxalate, methyl lactate, ethyl lactate, n-butyl lactate, n-amyl lactate, methyl pyruvate, ethyl pyruvate, diethyl malonate, dimethyl phthalate and diethyl phthalate. These esters can be used individually or in combination.

It should be noted that the use of an alcohol and/or an ester as a solvent is advantageous in that a coating composition having the good ability to form a coating and excellent storage stability can be obtained.

The coating composition of the present invention may contain the above-mentioned organic solvent. In the production of the coating composition, an organic solvent can be added to the production system not only before the hydrolysis/polycondensation reactions for producing silica precursor (A), but also during the hydrolysis/polycondensation reactions.

If desired, an additive can be incorporated into the coating composition of the present invention in such an amount as will not impair the effects of the present invention. Examples of additives include colloidal silica, a surfactant, a photocatalyst generator for imparting a photosensitivity, an agent for improving the adhesion to a substrate, and a stabilizer for a long-term storage.

From the viewpoint of suppression of leakage of current from the porous silica insulating thin film, the total amount of alkali metals (such as sodium and potassium) and iron in the coating composition is preferably 15 ppb or less, more preferably 10 ppb or less, based on the weight of the coating composition. It is possible that alkali metals and iron are sometimes present as impurities in the raw materials used for producing the coating composition. Therefore, it is preferred that the silica precursor (A), the organic polymer (B), the organic solvent and the like are purified by distillation or the like.

In the present invention, a silica/organic polymer composite thin film can be obtained by a method in which the above-mentioned coating composition as a coating liquid is applied onto a substrate to form a thin film, and the silica precursor (A) in the thin film is subjected to gelation.

As described above, by the present invention, in which at least one alkoxysilane having a specific structure is used in combination with the organic block copolymer having a specific structure, wherein a quaternary ammonium salt is optionally incorporated in combination with an acid having a pKa of from 1 to 11, and wherein the pH of the resultant coating composition (occasionally containing an organic solvent) is controlled to a level of less than 7, there can be obtained a coating composition exhibiting excellent storage stability, which can provide a porous silica insulating thin film having excellent hydrophobicity, a satisfactorily low relative dielectric constant and an extremely high mechanical strength, wherein the amount of gas generated from the porous silica insulating thin film during the above-mentioned via process can be suppressed to an extremely low level.

Hereinbelow, an explanation is made with respect to an example of methods for producing the coating composition of the present invention.

The coating composition of the present invention can be produced, for example, by a method comprising:

the first step (addition step) of adding an organic block copolymer to at least one alkoxysilane;

the second step (synthesis step) of adding water and an acid catalyst to the mixture obtained in the first step to perform hydrolysis/polycondensation reactions of the alkoxysilane;

the third step (adjustment step) of adjusting the amounts of water and an organic solvent, if any, in the mixture obtained in the second step;

the fourth step (addition step) of adding an acid having a pKa of from 1 to 11 to the mixture obtained in the third step; and

the fifth step (addition step) of adding a quaternary ammonium salt to the mixture obtained in the fourth step.

If desired, a filtration step can be additionally incorporated.

By the method comprising the above-mentioned five steps (these five steps are conducted in this order), the coating composition of the present invention for use in producing an insulating thin film can be easily produced.

With respect to the first step and the second step (synthesis step), an explanation is made below.

The first and second steps can be conducted as follows. At least one alkoxysilane as a starting raw material is added to a production system, and water and an acid catalyst are added to the production system to perform hydrolysis/polycondensation reactions of the alkoxysilane, followed by addition of an organic polymer and optionally an organic solvent. Alternatively, the first and second steps can also be conducted as follows. At least one alkoxysilane as a starting raw material is added to a production system, and an organic polymer and optionally an organic solvent are added to the production system, followed by addition of water and an acid catalyst to perform hydrolysis/polycondensation reactions of the alkoxysilane. Of these two manners, from the viewpoint of production of a coating composition which can give a porous silica insulating thin film having a high Young's modulus, the latter is preferred. That is, it preferred that the addition of an organic block copolymer is conducted before the addition of water and an acid catalyst.

With respect to the case where a cation exchange resin is used as an acid catalyst, a detailed explanation is made below.

To a mixture of at least one alkoxysilane and an organic block copolymer is dropwise added a mixture of water and a cation exchange resin to perform the hydrolysis/polycondensation reactions of the alkoxysilane. Then, from the resultant reaction mixture is removed the cation exchange resin by filtration.

The manner for dropwise adding the mixture of water and the cation exchange resin to the mixture of the alkoxysilane and the organic block copolymer is not specifically limited. For example, the addition of the mixture of water and the cation exchange resin may be conducted at one time, continuously or intermittently. To the contrary, the mixture of the alkoxysilane and the organic block copolymer may also be added to the mixture of water and the cation exchange resin. Further, depending on the advance of the hydrolysis/polycondensation reactions, a part of the water may be separately added to the production system.

Water is generally added to the production system in a form as such or in the form of a solution of thereof in an alcohol. Water may also be added in the form of steam. When the addition of water to the production system is conducted rapidly, it is possible that, depending on the type of the alkoxysilane, hydrolysis/polycondensation reactions proceed too fast, so that hydrolysis/polycondensation products are likely to be precipitated. For preventing the precipitation of hydrolysis/polycondensation products, various techniques can be employed. Examples of such techniques include a technique in which the addition of water is conducted over a considerable period of time; a technique in which a solvent, such as an alcohol, is used in combination with water; and a technique in which the addition of water is conducted at low temperatures. These techniques can be employed individually or in combination.

The organic solvent may be added to a mixture of the alkoxysilane and the organic block copolymer or to a mixture of water and the cation exchange resin.

For example, ethanol (organic solvent) may be added to a water-wetted cation exchange resin (i.e., a mixture of water and a cation exchange resin).

The at least one alkoxysilane is hydrolyzed to form silanols. Then, the silanol groups undergo polycondensation therebetween, thereby forming a silica precursor (in the form of an oligomer) having a siloxane linkage.

In the present invention, the organic polymer is preferably added after the alkoxysilane has grown into an oligomeric silica precursor, because (1) the viscosity of the coating composition is appropriately increased, so that the morphology of the thin film produced from the coating composition can be retained and, hence, the thin film has a uniform thickness; and (2) when the silica precursor is subjected to gelation, a silica skeleton is formed in a mild fashion, so that the shrinkage of the thin film is unlikely to occur.

The temperature (synthesis temperature) at which the hydrolysis/polycondensation reactions of the at least one alkoxysilane are performed is generally from 0 to 150° C., preferably from 0 to 100° C., more preferably from 0 to 50° C. The synthesis temperature can be changed continuously or intermittently. For example, the mixture of water and the acid catalyst may be added to the alkoxysilane while maintaining the temperature at 30° C., followed by elevation of the temperature to 50° C. to thereby perform hydrolysis/polycondensation reactions of the alkoxysilane. Alternatively, the mixture of water and the acid, or water may be dropwise added to the alkoxysilane in a continuous manner while elevating the synthesis temperature from 30° C. to 50° C.

In the synthesis step, a plurality of alkoxysilanes may be separately subjected to hydrolysis/polycondensations, followed by mixing together of the resultant hydrolysis/polycondensation products. If desired, the thus obtained mixture of hydrolysis/polycondensation products may be subjected to further hydrolysis/polycondensation.

The cation exchange resin used as a catalyst can be removed by filtration using a filter. The filtration can be conducted, for example, as follows. Hydrolysis/polycondensation reactions of the alkoxysilane are performed in the presence of the cation exchange resin, and the resultant reaction mixture is subjected to a vacuum filtration using a PTFE membrane having a pore diameter of 10 μm to thereby remove the cation exchange resin from the reaction mixture. Alternatively, after a coating composition is produced using the cation exchange resin, the coating composition is subjected to a filtration under pressure using a polyethylene cartridge filter having a pore diameter of 0.05 μm to thereby remove the cation exchange resin.

Further, if desired, solid impurities can be removed from the production system by the above-mentioned filtration method at any time.

The so-called synthesis step is performed as described above.

In the next third step (adjustment step), the amounts of water and a solvent in the mixture obtained in the second step are adjusted. As described in Unexamined Japanese Patent Application Laid-Open Specification No. 2001-02932, by the removal or addition of water and a solvent, a coating composition having a desired formulation can be obtained.

Examples of methods for removing water and the solvent include distillation methods, such as simple distillation under pressure, precision distillation, Arthur distillation and thin film distillation; extraction; and ultrafiltration. Distillation can be conducted under atmospheric pressure or reduced pressure. However, when the distillation is conducted under atmospheric pressure, the distillation temperature is generally high, leading to a danger such that solidification of the silica precursor occurs during the distilling off of water and the solvent. Therefore, it is preferred that the distillation is conducted under reduced pressure.

If desired, an organic polymer and a solvent, each functioning as a gelation preventing agent or a viscosity reducing agent, can be used before and/or after the distillation.

The distillation temperature is preferably from 0 to 100° C., more preferably from 10 to 80° C.

Further, when the addition of water and a solvent is necessary for obtaining a coating composition having a desired formulation, the addition can be conducted by a conventional method. The adjustment of the formulation of the coating composition can also be conducted by addition of an organic polymer or the like.

In the fourth step, an acid having a pKa of from 1 to 11 is added to the mixture obtained in the third step. The method for addition of the acid is not particularly limited, and the addition can be conducted under general stirring conditions.

In the fifth step, a quaternary ammonium salt is added to the mixture obtained in the fourth step, thereby obtaining the coating composition of the present invention. The method for addition of the quaternary ammonium salt is not particularly limited, and the addition can be conducted under general stirring conditions.

The quaternary ammonium salt may, prior to use thereof, be diluted with water or a solvent, or mixed with an acid having a pKa of from 1 to 11.

By the above-mentioned method, the coating composition of the present invention can be easily produced.

The above explanation on the method for producing the coating composition of the present invention should not be construed as limiting the scope of the present invention. The coating composition can also be produced by conducting the above-mentioned steps in an order different from the order mentioned above.

For example, in the first step, it is possible to use an acid having a pKa of from 1 to 11, which functions both as an acid catalyst and as the acid as component (C). Further, the third step (i.e., the step of adjusting the amounts of water and optionally the solvent) may be sequentially conducted. Also, the fourth step (i.e., the step of adding an acid) may be conducted in any step. Furthermore, the addition of a quaternary ammonium salt may be conducted before, simultaneously with, or after the addition of the acid in the fourth step. Therefore, the fifth step (i.e., the step of adding a quaternary ammonium salt) may be conducted in any step after the first step so long as the above-mentioned requirements are satisfied.

As apparent from the above, the above-described method for producing the coating composition of the present invention has a characteristic feature that hydrolysis/polycondensation reactions of at least one alkoxysilane are performed in the presence of an acid catalyst in a production system and, if desired, an acid having a pKa of from 1 to 11 is added, followed by addition of a quaternary ammonium salt, thereby producing a coating composition, wherein the pH in the production system is maintained in the range of less than 7 during the production of the coating composition. Various modifications can be made to the five-step method mentioned above so long as the modified methods satisfy the above characteristic feature. It should be noted that, by maintaining the pH of the coating composition at a level in the range of less than 7, rapid elevation of the viscosity of the composition and solidification of the composition can be prevented.

Polycondensation of hydrolysis products of the alkoxysilane advances much faster under conditions wherein the pH is 7 or more than under conditions wherein the pH is less than 7. Therefore, when the amount of the acid having a pKa of from 1 to 11 in the production system is small at the time of addition of the quaternary ammonium salt, the composition obtained after the addition of the quaternary ammonium salt is likely to exhibit a pH value of 7 or more, so that rapid elevation of the viscosity of the composition and solidification of the composition are likely to occur, thereby rendering it difficult to produce a coating composition suitable for use in producing an insulating thin film.

Hereinbelow, a detailed explanation is made with respect to the method in which the coating composition of the present invention is coated on a substrate to thereby form a thin film of the coating composition on the substrate, to the method in which the thin film is subjected to gelation with respect to the silica precursor in the thin film to obtain a silca/organic polymer composite thin film, and to the method in which the organic polymer is removed from the silca/organic polymer composite thin film to thereby produce the porous silica thin film of the present invention.

As mentioned above, it is preferred that the coating composition of the present invention has a silica precursor concentration in the range of from 2 to 30% by weight. The silica precursor concentration of the coating composition varies depending on the use of the coating composition. When the silica precursor concentration of the coating composition is in the range of from 2 to 30% by weight, the storage stability of the coating composition is enhanced and it would be easy to obtain a thin film of the coating composition having a desired thickness. If desired, the adjustment of the silica precursor concentration of the coating composition can be conducted by concentrating the coating composition, or diluting the coating composition with the above-mentioned organic solvent.

The silica precursor concentration is defined as the weight percentage, based on the weight of the coating composition, of the total of siloxanes formed by the hydrolysis/polycondensation reactions of the whole amount of the at least one alkoxysilane.

The formation of the thin film is performed by coating the coating composition of the present invention on a substrate. As a method for forming the thin film, any conventional method, such as casting, immersing or spin-coating, can be employed. However, the spin coating method is preferred when it is intended to use the thin film for an insulating layer for a multilevel interconnect for a semiconductor device. The thickness of the thin film can be controlled within the range of from 0.1 to 100 μm by varying the viscosity of the coating composition and the revolution rate of the spin coater. The thickness of the thin film is preferably from 0.1 to 100 μm, more preferably from 0.1 to 20 μm, still more preferably from 0.1 to 5 μm. When the thickness of the thin film is larger than 100 μm, the thin film tends to suffer cracking. When it is intended to use the thin film for an insulating layer for a multilevel interconnect for a semiconductor device, the thickness of the thin film is generally in the range of from 0.1 to 5 μm.

Examples of substrates include substrates comprised of a single element substance semiconductor, such as silicon or germanium, and substrates comprised of a compound semiconductor, such as gallium-arsenic or indiumantimony. These semiconductor substrates may be used in a form having formed thereon a thin film of a substance other than the substance used as a material for the substrate. Examples of substances for such a thin film formed on a semiconductor substrate include metals, such as aluminum, titanium, chromium, nickel, copper, silver, tantalum, tungsten, osmium, platinum and gold; inorganic compounds, such as silicon dioxide, fluorinated glass, phosphate glass, borate-phosphate glass, borosilicate glass, polycrystalline silicon, alumina, titania, zirconia, silicon nitride, titanium nitride, tantalum nitride, boron nitride, hydrogen silsesquioxane; and organic polymers, such as methyl silsesquioxane, amorphous carbon, fluorinated amorphous carbon, a polyimide and any organic block copolymer.

Prior to the formation of the thin film of the composition on a substrate, the surface of the substrate may be treated with an agent for improving the adhesion to the thin film. As examples of agents for improving the adhesion to the thin film, there can be mentioned substances used as a so-called silane coupling agent, or chelate compounds of aluminum. Especially preferred examples of agents for improving the adhesion include 3aminopropyltrimethoxysilane, 3-aminopropyltriethoxysilane, N-(2-aminoethyl)-3-aminopropyltrimethoxysilane, N-(2-aminoethyl)-3-aminopropylmethyldimethoxysilane, vinyltrichlorosilane, vinyltriethoxysilane, 3-chloropropyltrimethoxysilane, 3-chloropropylmethyldichlorosilane, 3-chloropropylmethyldimethoxysilane, 3-chloropropylmethyldiethoxysilane, 3-mercaptopropyltrimethoxysilane, 3-glycidoxypropyltrimethoxysilane, 3-glycidoxypropylmethyldimethoxysilane, 3-methacryloxypropyltrimethoxysilane, 3-methacryloxypropylmethyldimethoxysilane, hexamethyldisilazane, (ethyl acetoacetato)aluminum diisopropylate, tris(ethyl acetoacetato)aluminum, bis(ethyl acetoacetato)aluminum monoacetylacetonate, and tris(acetylacetonato)aluminum. If desired, when the agent for improving the adhesion to the thin film is applied onto a substrate, other additives may be added to the agent, and the agent may be diluted with a solvent. The treatment of the surface of the substrate with the agent for improving the adhesion to the thin film is conducted by a conventional method.

After formation of the thin film of the coating composition, the thin film is subjected to gelation with respect to the silica precursor in the thin film. With respect to the temperature at which the silica precursor in the thin film is subjected to gelation, there is no particular limitation. However, the temperature is generally in the range of from 100 to 300° C., preferably from 150 to 300° C., more preferably from 150 to 250° C. The time for gelation of the silica precursor varies depending on the temperature employed for the gelation, the amount of the catalyst, and the type and amount of the solvent. However, the time for gelation of the silica precursor is generally in the range of from several seconds to 10 hours, preferably from 30 seconds to 5 hours, more preferably from 1 minute to 2 hours. By this method, gelation of the silica precursor in the coating composition is satisfactorily performed, thereby obtaining silica. The thus obtained silica sometimes has a condensation ratio of nearly 100%. In general, the condensation ratio of silica exceeds 90% or so. In the present invention, the term “gelation of the silica precursor” means that the silica precursor is subjected to hydrolysis/polycondensation reactions to obtain a silica precursor having a condensation ratio exceeding 90% or so. When the gelation of the silica precursor contained in the thin film of the coating composition of the present invention is conducted by the above-mentioned method, substantially all of the water and alcohol contained in the thin film are removed.

The condensation ratio of the product obtained by gelation of the silica precursor in the thin film can be determined by solid-state nuclear magnetic resonance (NMR) spectroscopy, infrared (IR) absorption spectroscopy or the like. When the gelation is conducted at a temperature lower than 100° C., disadvantages are likely to be caused wherein, in the subsequent process for removing the organic polymer, the removal of the polymer starts before the gelation of the silica precursor has satisfactorily proceeded, so that the density of the thin film becomes disadvantageously high. On the other hand, when the gelation is conducted at a temperature higher than 300° C., formation of large voids tends to occur, so that uniformity of the silica/organic polymer composite thin film is lowered.

The thus obtained silica/organic polymer composite thin film has low relative dielectric constant, and can be formed so as to have a large thickness. Therefore, the silica/organic polymer composite thin film as such can be used as an insulating portion of a circuit. Further, the silica/organic polymer composite thin film can also be put to other uses. For example, the thin film can be used as an optical film, a structural material, a film, a coating material and the like. However, from the viewpoint of obtaining a material having a further lower relative dielectric constant, which can be used as an insulating thin film for a multilayer interconnect for an LSI, it is preferred to convert the silica/organic polymer composite to a porous silica thin film.

The conversion of the silica/organic polymer composite thin film to the porous silica insulating thin film is conducted by removing the organic polymer from the silica/organic polymer composite thin film. If the gelation of the silica precursor has satisfactorily proceeded, when the organic polymer is removed from the silica/organic polymer composite thin film, the spaces in the silica/organic polymer composite thin film, which had been occupied by the organic polymer, are not collapsed but left as pores in the porous silica thin film. As a result, a porous silica thin film having a high void ratio and hence a low relative dielectric constant can be obtained.

Examples of methods for removing the organic polymer from the silica/organic polymer composite thin film include heating, plasma treatment and solvent extraction. Of these methods, heating is most preferred, since heating can be easily performed in the current process for producing a semiconductor device. When the organic polymer is removed by heating, the heating temperature varies depending on the type of the organic polymer used. Some organic polymers are removed simply by evaporation/dissipation which is not accompanied by degradation of the organic polymers. Other organic polymers are removed by calcination accompanied by degradation of the organic polymers. Further, there is a case where the organic polymer is removed by a combination of evaporation/dissipation with calcination. The temperature for heating the silica/organic polymer composite thin film is generally from 300 to 450° C., preferably from 350 to 400° C. When the heating temperature is lower than 300° C., there is a danger such that the organic polymer is not satisfactorily removed, so that some organic substances derived from the organic polymer may remain as impurities in the resultant porous silica thin film and, hence, it becomes very difficult to obtain a porous silica thin film having a low relative dielectric constant. Further, a large amount of contaminated gas is likely to be generated. On the other hand, when the heating temperature is higher than 450° C., such a high temperature is preferred from the viewpoint of removing the organic polymer, but it is difficult to incorporate this heating method into the current process for producing a semiconductor device.

It is preferred that the heating is conducted for a period of from 10 seconds to 24 hours, more preferably from 10 seconds to 5 hours, most preferably from 1 minute to 2 hours. When the heating time is shorter than 10 seconds, the organic polymer is not satisfactorily evaporation-dissipated or thermally decomposed, so that some organic substances derived from the organic polymer may remain as impurities in the resultant porous silica thin film and, hence, the relative dielectric constant of the porous silica thin film is not lowered. In general, thermal decomposition or evaporation/dissipation of the organic polymer is completed within 24 hours. Therefore, a long-time heating for more than 24 hours is useless.

It is preferred that the heating is conducted in an atmosphere of inert gas, such as nitrogen, argon or helium gases. The heating can also be conducted in an oxidizing atmosphere containing air or oxygen gas. In this case, it is preferred that the oxidizing gas concentration is controlled within a range wherein the organic polymer is substantially not decomposed prior to gelation of the silica precursor. Further, the heating can be conducted in an atmosphere of a gas containing ammonia, hydrogen and the like. In this case, a silanol group remaining in the silica can be deactivated, thereby making it possible to lower the hygroscopicity of the porous thin film and suppress the increase in the relative dielectric constant of the porous silica thin film.

By removing the organic polymer from the silica/organic polymer composite thin film under the above-mentioned heating conditions, a porous silica insulating thin film is obtained, wherein the amount of the organic polymer remaining in the porous silica insulating thin film is so small that the amount of gas generated from the porous silica insulating thin film during the above-mentioned via process can be suppressed to an extremely low level. Therefore, an insulating laminate structure comprising the porous silica insulating thin film as a layer has an advantage in that the insulating laminate structure is free from a danger such that the adhesion between the porous silica thin film layer and a layer (of the laminate structure) adjacent to the porous silica thin film layer is lowered or that the adjacent layer is detached from the porous silica thin film layer. This advantage is remarkable especially when the organic polymer in the coating composition comprises not only a polyether block copolymer but also a component organic polymer (other than the block copolymer) having a terminal group which is inert to the silica precursor.

As described above, the porous silica insulating thin film of the present invention can be produced from the thin film of the coating composition of the present invention by a method comprising the steps of forming a silica/organic polymer composite thin film, and removing the organic polymer from the silica/organic polymer composite thin film, wherein these two steps are conducted under the above-mentioned conditions. If desired, the method may further comprise an additional step of heating the thin film of the coating composition or the silica/organic polymer composite thin film. This additional step may be conducted before the step of forming the silica/organic polymer composite thin film, between the step of forming the silica/organic polymer composite thin film and the step of removing the organic polymer, or after the step of removing the organic polymer. With respect to the temperature and atmosphere employed for the heating in the additional step, there is no particular limitation.

In the present invention, the heating of the silica/organic polymer composite thin film can be conducted by means of a conventional apparatus used in the current semiconductor device production process, such as a furnace or a hot plate type calcination system. Needless to say, there is no particular limitation with respect to the apparatus used for heating the silica/organic polymer composite thin film so long as the heating is conducted under the above-mentioned conditions.

As apparent from the above, the porous silica insulating thin film of the present invention can be advantageously used as an insulating thin film in a multilevel interconnect for an LSI, which is required to exhibit excellent hydrophobicity, a satisfactorily low relative dielectric constant and an extremely high mechanical strength. The relative dielectric constant of the porous silica insulating thin film is generally from 2.8 to 1.2, preferably from 2.3 to 1.2, more preferably from 2.3 to 1.6. The relative dielectric constant of the porous silica insulating thin film can be controlled by adjusting the amount of the component (B) (i.e., the organic polymer) in the coating composition of the present invention. Further, when the porous silica insulating thin film is subjected to pore size distribution analysis in accordance with the BJH method, substantially no pores having a diameter of 30 nm or more are observed. Therefore, the porous silica insulating thin film is preferably used as an insulating layer for a laminate structure comprising a plurality of layers. In general, no pores having a diameter of 20 nm or more are observed in the porous silica thin film.

When the porous silica insulating thin film has a functional group represented by the below-mentioned formula (4), the mechanical strength of the porous silica insulating thin film is further improved. The reason for this improvement of the mechanical strength is presumed to be that, when the thin film has a covalent bonding between silicon atoms as in the formula (4), the crosslinking density thereof is improved as compared to the case of the thin film having no such covalent bonding.

When the coating composition of the present invention contains, as the silica precursor (A), the alkoxysilane represented by the formula (2) (i.e., the alkoxysilane (b)) and/or a hydrolysis/polycondensation product formed by hydrolysis/polycondensation reactions of the alkoxysilane, the porous silica insulating thin film obtained from the coating composition has a group represented by the following formula (4):

—Si—(R)ₚ—Si— (4)

wherein R represents an oxygen atom or a group —(CH₂)ᵣ— in which r represents an integer of from 1 to 6, and p represents 0 or 1.

One of the structural characteristics of the porous silica insulating thin film of the present invention is that the difference between the skeletal density of the porous silica insulating thin film and the apparent density of the porous thin insulating film is generally 0.2 or more, preferably 0.4 or more (the methods for measuring the skeletal density and apparent density of thin films, and the results of the measurements on specific thin films are described in detail in the present specification under the “BEST MODE FOR CARRYING OUT THE INVENTION”).

The skeletal density of the porous silica insulating thin film directly influences the mechanical strength of the thin film. When the difference between the skeletal density of the thin film and the apparent density of the thin film is 0.2 or more, the thin film has a mechanical strength sufficient for practical use. As mentioned above, the difference between the skeletal density and the apparent density is preferably 0.4 or more.

The high skeletal density of the porous silica insulating thin film is achieved especially when a triblock copolymer containing the structure represented by the formula (3) is used as the organic block copolymer which is a component of the organic polymer (B).

The reason why the porous silica insulating thin film has high skeletal density is presumed to be that the presence of the organic block copolymer functioning as a surfactant, the respective ratios of the polymer blocks constituting the organic block copolymer, and the strength and concentration of the acid catalyst, together, contribute to form a silica skeleton having high density in the thin film, so that the thin film exhibits high skeletal density.

The thickness of the porous silica insulating thin film is 100 μm or less, preferably 50 μm or less, more preferably 10 μm or less. When the thickness of the thin film is larger than 100 μm, there is a danger such that the thin film suffers cracking.

Lastly, an explanation is made below with respect to the insulating laminate structure of the present invention. The insulating laminate structure of the present invention comprises an organic insulating layer comprised of an organic compound, the inorganic insulating layer comprised of the above-mentioned porous silica thin film, and optionally a mixed layer disposed between the organic insulating layer and the inorganic insulating layer, wherein the mixed layer comprises the organic compound and the porous silica insulating thin film. In the laminate structure, the organic insulating layer and the inorganic insulating layer (comprised of the porous silica thin film) may be used as an upper layer and a lower layer, respectively. Alternatively, the organic insulating layer and the inorganic insulating layer may be used as a lower layer and an upper layer, respectively.

With respect to the type of the organic compound used in the organic insulating layer, there is no particular limitation so long as the organic compound is soluble in a solvent used and, after coating thereof, can be cured and rendered insulating by heating, as in the formation of the porous silica insulating thin film.

Examples of organic compounds used in the organic insulating layer include a polyimide resin, a fluorocarbon resin, a benzocyclobutene resin, a polyallyl ether resin, a polyallyl fluoride ether resin, a cyclic perfluoro resin, a polyquinoline resin, an aromatic resin and an oxazole resin. These organic compounds can be used individually or in combination.

Specific examples of insulating laminate structures are shown in FIGS. 1 and 2. In the insulating laminate structures shown in FIGS. 1 and 2, the porous silica insulating thin film of the present invention is used in a trench portion and a via portion, respectively. Conventionally, an etch stop film having a high relative dielectric constant is deposited between two layers comprising the same material by the CVD method (Chemical Vapor Deposition method). By contrast, however, in the laminate structure of the present invention, the etching property of the organic layer comprised of an organic resin is greatly different from the inorganic layer comprised of the porous silica thin film and, hence, there is no need to form an etching layer between the organic layer and the inorganic layer. As a result, the insulating laminate structure of the present invention exhibits an extremely low effective dielectric constant, which is one of the most characteristic features of the insulating laminate structure of the present invention.

The thickness of the mixed layer, which is formed between the organic layer and the inorganic layer, is preferably 100 nm or less, more preferably 50 nm or less. When the thickness of the mixed layer is larger than 100 nm, the laminate structure disadvantageously has a high relative dielectric constant.

With respect to the density of the layers of the insulating laminate structure of the present invention, the density of the organic insulating layer comprised of an organic compound and the density of the inorganic insulating layer comprised of the porous silica insulating thin film are within the range of from 0.3 to 2.0 g/cm³.

The porous silica insulating thin film of the present invention can also be used as a porous silica structure in a bulk form other than a thin film. Examples of porous silica structures in a bulk form include an optical film (such as an anti-reflection film or an optical waveguide), a catalyst support, a heat insulating material, an absorbent, a column filling material, an anti-caking agent, a thickening agent, a pigment, an opacifying agent, ceramic, an anti-smoking agent, an abrasive and a tooth paste.

In the above, a detailed explanation has been made with respect to the coating composition of the present invention and the method for producing the same. The characteristic features of the present invention and the effects thereof are summarized below.

(1) Effect of improving the modulus of the porous silica insulating thin film by addition of the organic polymer comprising an organic block copolymer to the alkoxysilane(s) before the hydrolysis/polycondensation reactions of the alkoxysilane(s):

When the hydrolysis/polycondensation reactions of the alkoxysilane(s) are performed in the presence of the organic block copolymer, there is formed, by the function of the organic block copolymer as a surfactant, a micell-like structure in which the molecules of the organic block copolymer are caused to appropriately coordinate around the silica precursors, which grow with the advance of the hydrolysis/polycondensation reactions of the alkoxysilane(s). In the micell-like structure, with respect to the organic block copolymer (which becomes the seeds for the pores in the porous silica insulating thin film) and the silica precursor (which forms a skeleton of the porous silica insulating thin film), microphase separation from each other occurs. This microphase separation is maintained in the porous silica insulating thin film obtained by coating the coating composition on a substrate and heating the resultant thin film. Therefore, the porous silica insulating thin film is caused to have a structure in which the pores and the skeleton are distinctly separated from each other and the skeleton is thick and strong. Accordingly, the porous silica insulating thin film exhibits an extremely high mechanical strength.

(2) Effect achieved by the use of the combination of a quaternary ammonium salt and an acid having a pKa of from 1 to 11:

When the combination of a quaternary ammonium salt and an acid having a pKa of from 1 to 11 is used in the coating composition, the quaternary ammonium salt (which is a basic compound) and the acid are neutralized with each other to form a salt. The coating composition is coated on a substrate to form a thin film. Then, the thin film is heated to remove a solvent, such as water, from the thin film to thereby obtain a silica/organic polymer composite thin film, followed by removal of the organic polymer from the silica/organic polymer composite thin film to thereby form a porous silica insulating thin film. During this stage, the acid having a pKa of from 1 to 11 (which is a comparatively weak acid) is preferentially evaporation-dissipated from the thin film and, hence, the pH value of the thin film shifts to the basic range. Therefore, the polycondensation reaction between silanol groups is extremely accelerated as compared to the case where the polycondensation reaction is performed under non-basic conditions. As a result, the silanol group concentration of the thin film is remarkably lowered (it should be noted that the presence of silanol groups in the thin film is one of the main cause of a lowering of the hydrophobicity of the thin film), so that the thin film exhibits an improved hydrophobicity and a remarkably low relative dielectric constant.

### BEST MODE FOR CARRYING OUT THE INVENTION

Hereinbelow, the present invention will be described in more detail with reference to the following Examples and Comparative Examples, which should not be construed as limiting the scope of the present invention.

In the following Examples and Comparative Examples, various properties were measured, calculated and evaluated by the following methods.

(1) Amounts of water and ethanol contained in a coating composition:

To 1 ml of a coating composition is added 0.2 g of dimethoxyethane as an internal standard, thereby obtaining a sample mixture. The sample mixture is analyzed using a gas chromatography (GC) apparatus (trade name: Gas Chromatography GC-7A, manufactured and sold by Shimadzu Corporation, Japan) to determine the amounts of water and ethanol contained in the coating composition. The conditions for the GC are as follows:

Column: Gaskuropack 56 (manufactured and sold by GL Sciences Inc., Japan);

Temperature programming: initially, the temperature is maintained at 100° C. for 2 minutes, then the temperature is elevated at a rate of 10° C./min to 200° C., and then the temperature is maintained at 200° C. for 16 minutes; and

Detector: TCD (thermal conductivity detector).

The amounts of the water and ethanol contained in the coating composition are determined in terms of the peak area ratios of water and ethanol to the internal standard in a chromatogram obtained by the GC, by using calibration curves separately prepared.

(2) Concentrations of the silica precursor and organic polymer of a coating composition:

The weight of the silica precursor in a coating composition is given in terms of the total weight of a siloxane formed by the hydrolysis/polycondensation reactions of the whole amount of an alkoxysilane used for producing the coating composition. For example, when 1 mol of tetramethoxysilane is used as an alkoxysilane for producing a coating composition, 1 mol of tetramethoxysilane is converted to 1 mol of SiO₂, which has a weight of 60.1 g. Therefore, the weight of the silica precursor is 60.1 g in terms of the weight of a siloxane. When a plurality of alkoxysilanes are used, the weight of the silica precursor is given in terms of the total weight of the plurality of alkoxysilanes, wherein the weight of each alkoxysilane is given in terms of a siloxane formed by the hydrolysis/polycondensation reactions of the whole amount of the alkoxysilane. The concentration of the silica precursor in the coating composition is defined as the weight percentage, based on the weight of the coating composition, of the above-mentioned weight of the silica precursor.

The weight of the organic polymer contained in the coating composition is given in terms of the weight of the organic polymer used for producing the coating composition. The concentration of the organic polymer in the coating composition is defined as the weight percentage, based on the weight of the coating composition, of the weight of the organic polymer.

(3) Storage stability of a coating composition:

From the coating composition obtained, two porous silica insulating thin films (i.e., first and second porous silica insulating thin films) are produced as follows. Directly after the production of the composition, the first thin film is produced using a part of the coating composition. On the other hand, another part of the coating composition is stored at 23° C. for a month, and the second thin film is produced using the coating composition having been stored at 23° C. for a month. The thicknesses of the first and second thin films are measured by the below-mentioned method (see item (6) below). A thickness change ratio is defined as the percentage, based on the thickness of the first thin film, of the difference between the thicknesses of the first and second thin films. Using this thickness change ratio, the storage stability of the coating composition is evaluated by the following criteria:

Good: the thickness change ratio is less than 3%.

Fairly good: the thickness change ratio is from 3% to less than 5%.

Poor: the thickness change ratio is 5% or more.

(4) Mole percentage, based on the molar amount of the silica in a coating composition, of each alkoxysilane in the coating composition:

The mole percentage, based on the molar amount of the silica in a coating composition, of each alkoxysilane in the coating composition was measured by ²⁹Si-NMR. For example, when the coating composition is produced using tetraethoxysilane (TEOS), dimethylethoxysilane (DMDES) and 1,2-bis(triethoxysilyl)ethane (BTSE) as alkoxysilanes, the mole percentage, based on the molar amount of the silica in the coating composition, of DMDES in the coating composition is measured as follows.

²⁹Si-NMR is conducted under the following conditions:

Apparatus: JEOL-Lambda 400 (manufactured and sold by JEOL LTO., Japan);

Measurement mode: NNE (quantitative mode);

Sample tube: 10 mm (outer diameter); 3 mm (inner diameter) (deuterated ethanol (C₂D₅OD) and a small amount of tetramethylsilane are placed in the inner tube and the coating composition is placed in the outer tube);

Number of integration: 1,300 times;

PD (pulse delay): 250 seconds; and

BF (broadening factor): 30 Hz.

The integral intensity of each signal is measured by the ²⁹Si-NMR under the above-mentioned conditions. Using the integral intensity of each signal, the mole percentage, based on the molar amount of the silica in the coating composition, of DMDES in the coating composition is calculated by the following formula:

$$\begin{matrix}\begin{matrix}Mole percentage \\ of DMDES\end{matrix} = 100 \times ( D0 + D1 + D2 ) / \{ ( T0 + T1 + T2 + T3 + T4 ) + \\ ( D0 + D1 + D2 ) + ( B0 + B1 + B2 + B3 ) \}\end{matrix}$$

wherein T0 represents the integral intensity of the signal ascribed to the silicon atom (of TEOS) which is not present as such a group as is formed by linkage thereof to another silicon atom through an oxygen atom; D0 represents the integral intensity of the signal ascribed to the silicon atom (of DMDES) which is not present as such a group as is formed by linkage thereof to another silicon atom through an oxygen atom; B0 represents the integral intensity of the signal ascribed to the silicon atom (of BTSE) which is not present as such a group as is formed by linkage thereof to another silicon atom through an oxygen atom; T1 represents the integral intensity of the signal ascribed to a group formed by linkage of the silicon atom of the TEOS to another silicon atom through an oxygen atom; D1 represents the integral intensity of the signal ascribed to a group formed by linkage of the silicon atom of the DMDES to another silicon atom through an oxygen atom; B1 represents the integral intensity of the signal ascribed to a group formed by linkage of a silicon atom of the BTSE to another silicon atom through an oxygen atom; T2 represents the integral intensity of the signal ascribed to a group formed by linkage of the silicon atom of TEOS to two other silicon atoms each through an oxygen atom; D2 represents the integral intensity of the signal ascribed to a group formed by linkage of the silicon atom of DMDES to two other silicon atoms each through an oxygen atom; B2 represents the integral intensity of the signal ascribed to a group formed by linkage of the silicon atom of BTSE to two other silicon atoms each through an oxygen atom; T3 represents the integral intensity of the signal ascribed to a group formed by linkage of the silicon atom of TEOS to three other silicon atoms each through an oxygen atom; B3 represents the integral intensity of the signal ascribed to a group formed by linkage of a silicon atom of BTSE to three other silicon atoms each through an oxygen atom; and T4 represents the integral intensity of the signal ascribed to a group formed by linkage of the silicon atom of TEOS to four other silicon atoms each through an oxygen atom.

The mole percentages, based on the molar amount of the silica in the coating composition, of TEOS and BTSE in the coating composition are measured in substantially the same manner as in the case of the mole percentage, based on the molar amount of the silica in the coating composition, of DMDES in the coating composition.

(5) Hydrophobicity of a thin film:

Water in an amount of 1 μl is dropped on a thin film. One minute after the dropping of water to the thin film, the contact angle of water against the surface of the film is measured using FACE CONTACT ANGLE METER (manufactured and sold by KYOWA INTERFACE SCIENCE CO., LTD., Japan). The hydrophobicity of the thin film is evaluated by the following criteria:

Very good: the contact angle is 95° or more.

Good: the contact angle is from 85° to less than 95°.

Fairly good: the contact angle is from 70° to less than 85°.

Poor: the contact angle is less than 70°.

(6) Thickness of a thin film:

The thickness of a thin film is measured using an X-ray diffractometer (trade name: RINT 2500; manufactured and sold by Rigaku Corporation, Japan). The measurement conditions are as follows:

Divergency slit: (⅙)°;

Scatter slit: (⅙)°;

Light receiving slit: 0.15 mm;

Detector: scintillation counter (a graphite monochrometer is placed before the scintillation counter);

Tube voltage: 40 kV; and

Tube current: 50 mA.

Further, the scintillation counter is scanned by means of a goniometer by the 2θ/θ method, wherein the scanning step is 0.02°.

(7) Relative dielectric constant of a thin film:

The relative dielectric constant of a thin film was measured at 1 MHz by means of an automatic mercury CV measurement apparatus (trade name: SSM495 Model; manufactured and sold by Solid State Measurement Company, U.S.A.).

(8) Young's modulus of a thin film (yardstick for the mechanical strength of the thin film):

Using Nano Indenter DCM (manufactured and sold by MTS Systems Corporation, U.S.A.), the Young's modulus of a thin film was measured as follows.

A Berkovich indenter made of diamond is thrust into a sample of a thin film until the load imposed on the sample reaches a predetermined level. Then, the indenter is pulled out from the sample. By monitoring the displacement of the indenter (i.e., the depth of indenter thrust into the sample) corresponding to the load imposed on the sample, a load/displacement curve is obtained. It is assumed that the indenter gets contact with the surface of the sample when the contact stiffness becomes 200 N/m. The hardness (H) is calculated by the following formula:

H=P/A

wherein P represents the load imposed on the sample, and A represents the contact area.

In the above formula, the contact area A is a function of the contact depth (h_{c}) and is represented by the following empirical formula:

A=24.56h_{c}²

The contact depth (h_{c}) and the displacement (h) of the indenter have a relationship represented by the following formula:

h_{c}=h−(εP)/S

wherein ε is 0.75 and S represents the slope of the tangent of the unloading curve.

For obtaining the Young's modulus (Eₛ) of the sample, the following Sneddon's formula is used:

Eᵣ=(\sqrt{π}·S)/(2\sqrt{A})

wherein Eᵣ represents the complex elasticity.

Eᵣ and Eₛ have a relationship represented by the following formula:

Eᵣ={(1−νₛ²)/Eₛ+(1−νᵢ²)/Eᵢ}−1

wherein νₛ represents the Poisson's ratio of the sample, and νᵢ represents the Poisson's ratio of the indenter.

The calculation of Eₛ is made on the assumption that νᵢ is 0.07, Eᵢ is 1,141 GPa and νₛ is 0.18.

(9) Amount of gas generated from a thin film:

Using a thermogravimetric analysis apparatus (trade name: TGA-50 Model; manufactured and sold by Shimadzu Corporation, Japan), a thin film is subjected to a thermogravimetric analysis under conditions wherein the temperature of the thin film is elevated at a rate of 10° C./min from room temperature to 425° C. and is maintained at 425° C. for 60 minutes. The weights of the thin film before and after the thermogravimetric analysis are measured, and the weight decrease ratio (wt %) of the thin film caused by the thermogravimetric analysis is calculated. The amount of gas generated from the thin film is defined as the difference in weight between the thin film before and after the thermogravimetric analysis, and is evaluated by the following criteria:

Very good: the weight decrease ratio is less than 0.5% by weight.

Good: the weight decrease ratio is from 0.5% by weight to less than 1.0% by weight.

Fairly good: the weight decrease ratio is from 1.0% by weight to less than 5.0% by weight.

Poor: the weight decrease ratio is 5.0% by weight or more.

(10) Concentration of silicon atoms in a thin film, wherein the silicon atoms are derived from the structure represented by the formula (4) (i.e., —Si—(R)ₚ—Si—):

The concentration of silicon atoms in a thin film, wherein the silicon atoms are derived from the structure represented by the formula (4), was measured by solid state NMR. For example, when a thin film is produced using tetraethoxysilane (TEOS), dimethylethoxysilane (DMDES) and 1,2-bis(triethoxysilyl)ethane (BTSE) as alkoxysilanes, the concentration of silicon atoms (derived from DMDES) in the thin film is measured as follows.

It should be noted that the silicon atom in DMDES or BTSE can be distinguished from the silicon atom in TEOS by ²⁹Si-NMR and that the carbon atom in DMDES can be distinguished from the carbon atom in BTSE by ¹³C-NMR.

The ²⁹Si-NMR and the ¹³C-NMR are conducted under the following conditions:

1) Conditions for the ²⁹Si-NMR

Apparatus: MSL-400 (manufactured and sold by BRUKER, Germany);

Atomic nucleus observed: 2 Si;

Frequency for observation: 79.496 MHz;

Measurement mode: hpdec (DD/MAS);

Number of integration: 660 times;

Sample tube: 7 mmφ;

Pulse width: 5.5 μsec;

Waiting time: 60 sec;

Temperature for measurement: room temperature; and

Standard substance for chemical shift: talc.

In the above expression “hpdec (DD/MAS)”, “DD” means that ¹H decoupling is conducted only when emission of signals from the thin film caused by transmission of single pulses to the thin film occurs.

2) Conditions for the ¹³C-NMR

Apparatus: MSL-400 (manufactured and sold by BRUKER, Germany);

Atomic nucleus observed: ¹³C;

Frequency for observation: 100.614 MHz;

Measurement mode: hpdec (DD/MAS);

Number of integration: 220 times;

Sample tube: 7 mmφ;

Rotational frequency: 4,900 Hz;

Pulse width: 3.1 μsec;

Waiting time: 200 sec;

Temperature for measurement: room temperature; and

Standard substance for chemical shift: glycin (176 ppm).

The integral intensity of each signal is measured under the above-mentioned conditions. Using the integral intensity of each signal, the molar concentration of silicon atoms (derived from BTSE) in the thin film is calculated by the following formula:

$$\begin{matrix}Molar concentration \\ \begin{matrix}( mol \% ) of silicon atoms \\ derived from BTSE\end{matrix}\end{matrix} \begin{matrix}= 100 \times ( B0 + B1 + B2 + B3 ) / \\ \{ ( T0 + T1 + T2 + T3 + T4 ) + \\ ( D0 + D1 + D2 ) + ( B0 + B1 + B2 + B3 ) \}\end{matrix}$$

wherein T0 represents the integral intensity of the signal ascribed to the silicon atom (of TEOS) which is not present as such a group as is formed by linkage thereof to another silicon atom through an oxygen atom; D0 represents the integral intensity of the signal ascribed to the silicon atom (of DMDES) which is not present as such a group as is formed by linkage thereof to another silicon atom through an oxygen atom; B0 represents the integral intensity of the signal ascribed to the silicon atom (of BTSE) which is not present as such a group as is formed by linkage thereof to another silicon atom through an oxygen atom; T1 represents the integral intensity of the signal ascribed to a group formed by linkage of the silicon atom of the TEOS to another silicon atom through an oxygen atom; D1 represents the integral intensity of the signal ascribed to a group formed by linkage of the silicon atom of the DMDES to another silicon atom through an oxygen atom; B1 represents the integral intensity of the signal ascribed to a group formed by linkage of a silicon atom of the BTSE to another silicon atom through an oxygen atom; T2 represents the integral intensity of the signal ascribed to a group formed by linkage of the silicon atom of TEOS to two other silicon atoms each through an oxygen atom; D2 represents the integral intensity of the signal ascribed to a group formed by linkage of the silicon atom of DMDES to two other silicon atoms each through an oxygen atom; B2 represents the integral intensity of the signal ascribed to a group formed by linkage of the silicon atom of BTSE to two other silicon atoms each through an oxygen atom; T3 represents the integral intensity of the signal ascribed to a group formed by linkage of the silicon atom of TEOS to three other silicon atoms each through an oxygen atom; B3 represents the integral intensity of the signal ascribed to a group formed by linkage of a silicon atom of BTSE to three other silicon atoms each through an oxygen atom; and T4 represents the integral intensity of the signal ascribed to a group formed by linkage of the silicon atom of TEOS to four other silicon atoms each through an oxygen atom.

(11) Apparent and skeletal densities of a thin film:

The apparent density of a thin film was measured by the following method. A thin film is formed on a wafer. Using an X-ray diffractometer (trade name: ATX-G; manufactured and sold by Rigaku Corporation, Japan), X-ray is irradiated over the thin film at very small incident angles to thereby measure the total external reflection critical angle of X-ray. Based on the total external reflection critical angle of X-ray, the apparent density of the thin film is measured. With respect to this measurement method, reference is made, for example, on D. K. G. De Boer et al., “X-RAY SPECTROMETRY”, Vol. 24 (1995), pp. 91-100, and references cited therein.

The skeletal density of the thin film was measured by the following method. Using the above-mentioned X-ray diffractometer, X-ray is irradiated over the thin film so that the reflection angle is 0.1° smaller than the incident angle, thereby preventing specular reflection of X-ray from the thin film and measuring X-ray scattered by the pores of the thin film (based on the results of the measurement of the scattering, a scattering curve is obtained). With respect to this method, reference is made, for example, on Kazuhiko Omote et al., “Ekkusu sen bunseki no shinpo (Advance in X-ray analysis)”, Vol. 33 (2002), pp. 185-195, published by AGNE GIJUTSU CENTER, Japan.

From the results of the above measurement, the pore diameter distribution of the thin film is obtained (the method for obtaining the pore diameter distribution is explained below). As effective pores, only pores having a diameter of more than 2.5 nm are taken into consideration for calculation of the skeletal density of the thin film. The skeletal density (ρ_{w}) of the thin film is calculated by the following formula:

ρ_{w}=(2.2−ρₐᵥₑ)φ_{large}+ρₐᵥₑ

wherein ρₐᵥₑ represents the average density (i.e., apparent density) of the thin film, and φ_{large} represents the effective pore ratio, that is, the volume percentage, based on the total volume of the pores in the thin film, of the pores (in the thin film) having a diameter of more than 2.5 nm.

In the above-described formula, the value 2.2 is the density of a stable silicon oxide film obtained by heating a silicon wafer under oxidizing conditions. The value 2.2 is considered to be the upper limit which the density of a porous silica insulating thin film can reach.

The pore diameter distribution of the thin film is obtained as follows. When no correlation is found among the distances between the pores, it is assumed that the pores have a spherical or cylindrical shape. Based on this assumption, the above-mentioned scattering curve is fitted in accordance with a theoretical curve, thereby obtaining the pore diameter distribution of the thin film. With respect to this method, reference is made, for example, on Kazuhiko Omote et al., “Ekkusu sen bunseki no shinpo (Advance in X-ray analysis)”, Vol. 33 (2002), pp. 185-195, published by AGNE GIJUTSU CENTER, Japan. On the other hand, when a correlation is found among the distances between the pores, a theoretical curve selected by taking the correlation into consideration is also used for obtaining the pore diameter distribution. For example, when pores are present on paracrystal lattices, a theoretical curve obtained based on the paracrystal theory is used for fitting the above-mentioned scattering curve. With respect to each of the paracrystal theory and the theoretical scattering formulae, reference is made, for example, on T. Hashimoto, T. Kawamura, M. Harada and H. Tanaka, “Macromolecules”, Vol. 27 (1994), p. 3063, published by The American Chemical Society. It should be noted that, even in the case of an oriented system, the pore diameter distribution can be obtained by using the theoretical curves described in this document in combination with an oriented distribution function. In the present invention, the fitting is conducted under the following conditions.

### Fitting Conditions

Fitting range: 2θ>1° (wherein 2θ represents the scattering angle)

The scattering through the reflection from the substrate (wafer) is not taken into consideration since such a scattering vigorously occurs only in the range such that 2θ<1°.

The slit adjustment is not conducted since influence due to the slit is large only in the range such that 2θ<1°.

When no periodicity is found in the positional distribution of the pores, it is assumed that the pores are distributed in the thin film in accordance with the Shultz-Zimm (G) distribution. In this case, pores having a pore diameter less than 0.1 nm are not taken into consideration.

When a periodicity is found in the positional distribution of the pores, the morphology of the pores are determined, based on the above-mentioned scattering curve and the results of observation of the thin film by means of a transmission electron microscope. Then, using a theoretical formula based on the crystal theory, the pore diameter distribution is obtained.

When it is impossible to suitably fit the scattering curve by means of a single pore distribution function, the fitting is conducted by using a combination of two pore distribution functions. As examples of such combinations, there can be mentioned a combination of a pore distribution function (used when a periodicity is found in the positional distribution of the pores) and a pore distribution function (used when no correlation is found among the distances between the pores), and a combination of two pore distribution functions which are used when no correlation is found among the distances between the pores.

(12) Densities, thicknesses and surface roughnesses of the layers of an insulating laminate structure:

The measurements of the densities, thicknesses and surface roughnesses of the layers of an insulating laminate structure were conducted by the methods described in Shinya Matsuno et al., “Ekkusu sen bunseki no shinpo (Advance in X-ray analysis)”, Vol. 30 (1999), pp. 189-203, published by AGNE GIJUTSU CENTER, Japan.

(13) pH value of a coating composition:

The pH value of a coating composition was measured using a pH meter (trade name: F-21; manufactured and sold by HORIBA, Ltd., Japan).

In all Examples, and Comparative Examples except for Comparative Example 12, the pH values of the coating compositions produced were less than 7.

(14) Weight average molecular weight of a polymer:

The weight average molecular weight of a polymer was measured by gel permeation chromatography (GPC) using a calibration curve obtained with respect to a polyethylene glycol.

### EXAMPLE 1

107.0 g (0.6 mol) of methyltriethoxysilane as an alkoxysilane, 93.1 g (0.4 mol) of tetraethoxysilane as an alkoxysilane and 80.4 g of a 50% by weight ethanol solution of a polyethylene glycol/polypropylene glycol/polyethylene glycol block copolymer as an organic block copolymer were mixed together, wherein the block copolymer had a weight average molecular weight of 6,400, and the polypropylene glycol block of the block copolymer had a weight average molecular weight of 3,200. To the resultant mixture were added 0.3 g of a 0.9% by weight aqueous solution of oxalic acid (the amount of oxalic acid in the aqueous solution was 3×10⁻⁵ mol equivalents, relative to the Si atoms in the alkoxysilanes in the mixture) and 129.1 g of water to effect a reaction at 50° C. for 4 hours while stirring, thereby obtaining a reaction mixture.

70 g of the obtained reaction mixture was subjected to a distillation at 50° C. under 50 mmHg to remove water and ethanol from the mixture. The resultant mixture was concentrated to reduce the amount of the mixture to 23.0 g, followed by addition of 37.5 g of ethylene glycol monobutyl ether as an organic solvent, thereby obtaining a concentrated solution. The concentrated solution was analyzed by gas chromatography to measure the water and ethanol concentrations of the concentrated solution.

To 50 g of the concentrated solution were added 27.4 g of water, 3.5 g of ethanol and 19.1 g of ethylene glycol monobutyl ether to thereby obtain a coating composition. The obtained coating composition had a silica precursor concentration of 10% by weight, a polymer concentration of 6% by weight, a water concentration of 30% by weight, an ethanol concentration of 4% by weight, an ethylene glycol monobutyl ether concentration of 50% by weight, and an oxalic acid concentration of 4 ppm by weight.

The amount of the Si atoms (derived from methyltriethoxysilane) contained in the coating composition was 60 mol %, based on the total molar amount of the Si atoms contained in the coating composition.

With respect to the storage stability of the coating composition, the coating composition exhibited a film thickness change ratio of 1%, which was at a satisfactory level.

5 ml of the coating composition was dropwise applied onto a circular silicon wafer having a diameter of 8 inches and spin-coated at 1,000 rpm for 60 seconds to form a thin film of the coating composition on the silicon wafer. The thin film was calcined at 120° C. for 1 minute in air, calcined at 150° C. for 1 hour in a nitrogen atmosphere, and then calcined at 400° C. for 1 hour in a nitrogen atmosphere, thereby obtaining a porous silica insulating thin film.

The porous silica insulating thin film had a thickness of 0.97 μm, a relative dielectric constant of 2.3, a Young's modulus of 4.7 GPa, and a water contact angle of 90°, each of which was at a satisfactory level. Also, the porous silica insulating thin film had a weight decrease ratio of 2.7% by weight, which was at a fairly satisfactory level (it should be noted that the weight decrease of the porous silica insulating thin film was caused by generation of gas from the thin film). Further, the porous silica insulating thin film had an apparent density of 0.95 g/cm³ and a skeletal density of 1.75 g/cm³ and, hence, the difference between the skeletal density and the apparent density was 0.80 g/cm³. Furthermore, in the porous silica insulating thin film, no Si atom bonded to an alkylene group was observed.

### EXAMPLE 2

A coating composition was produced in substantially the same manner as in Example 1, except that, as an organic block copolymer, a polyethylene glycol/polytetramethylene glycol/polyethylene glycol block copolymer having a weight average molecular weight of 2,000, wherein the polytetramethylene glycol block of the block copolymer had a weight average molecular weight of 1,000, was used instead of the polyethylene glycol/polypropylene glycol/polyethylene glycol block copolymer having a weight average molecular weight of 6,400, wherein the polypropylene glycol block of the block copolymer had a weight average molecular weight of 3,200.

With respect to the storage stability of the coating composition, the coating composition exhibited a film thickness change ratio of 1%, which was at a satisfactory level.

Using the coating composition, a porous silica insulating thin film was obtained in substantially the same manner as in Example 1. The obtained thin film had a thickness of 1.01 μm, a relative dielectric constant of 2.3, a Young's modulus of 4.6 GPa and a water contact angle of 91°, each of which was at a satisfactory level. Also, the obtained thin film had a weight decrease ratio of 2.8% by weight, which was at a fairly satisfactory level (it should be noted that the weight decrease of the porous silica insulating thin film was caused by generation of gas from the thin film). Further, the thin film had an apparent density of 1.0 g/cm³ and a skeletal density of 1.75 g/cm³ and, hence, the difference between the skeletal density and the apparent density was 0.75 g/cm³. Furthermore, in the thin film, no Si atom bonded to an alkylene group was observed.

### EXAMPLE 3

A coating composition was produced in substantially the same manner as in Example 1, except that, as an organic block copolymer, a glycerol/polypropylene glycol/polyethylene glycol branched block copolymer having a weight average molecular weight of 6,000, wherein the propylene glycol block of the block copolymer had a weight average molecular weight of 1,000, was used instead of the polyethylene glycol/polypropylene glycol/polyethylene glycol block copolymer. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### EXAMPLE 4

A coating composition was produced in substantially the same manner as in Example 1, except that, as an organic block copolymer, a polypropylene glycol/polyethylene glycol block copolymer having a weight average molecular weight of 3,000, wherein the polypropylene glycol block of the block copolymer had a weight average molecular weight of 1,500, was used instead of the polyethylene glycol/polypropylene glycol/polyethylene glycol block copolymer. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### COMPARATIVE EXAMPLE 1

A coating composition was produced in substantially the same manner as in Example 1, except that, instead of an organic block copolymer, a polyethylene glycol having a weight average molecular weight of 600 was used. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

With respect to the thin film obtained in Comparative Example 1 in which a polyethylene glycol was used instead of an organic block copolymer, the difference between the skeletal density of the thin film and the apparent density of the thin film was 0.1 g/cm³ or less, and the thin film had a Young's modulus of 4 GPa or less, which is at an unsatisfactory level.

### COMPARATIVE EXAMPLE 2 TO 4

In Comparative Examples 2, 3 and 4, reaction mixtures were, respectively, obtained in substantially the same manners as in Examples 1, 2 and 3, except that the addition of the ethanol solution of each of the organic block copolymers was individually conducted after the alkoxysilanes, the oxalic acid solution and water were mixed together to perform a reaction at 50° C. for 4 hours while stirring. Using 70 g of each of the obtained reaction mixtures individually, coating compositions were produced by conducting substantially the same operations (including removal of a solvent by distillation, and concentration) as in Example 1. Properties of the obtained coating compositions were measured, calculated and evaluated by the above-mentioned methods. The results are shown in Table.

Using each of the coating compositions individually, porous silica insulating thin films were obtained in substantially the same manner as in Example 1. Properties of the obtained thin films were measured, calculated and evaluated by the above-mentioned methods. The results are shown in Table.

### EXAMPLE 5

A coating composition was produced in substantially the same manner as in Example 1, except that, as an organic block copolymer, a dimethoxy-polyethylene glycol/polypropylene glycol/polyethylene glycol block copolymer was used, which was obtained by modifying both terminals of a polyethylene glycol/polypropylene glycol/polyethylene glycol block copolymer with a methoxy group. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### EXAMPLE 6

A coating composition was produced in substantially the same manner as in Example 2, except that, as an organic block copolymer, a dimethoxy-polyethylene glycol/polytetramethylene glycol/polyethylene glycol block copolymer was used, which was obtained by modifying both terminals of a polyethylene glycol/polytetramethylene glycol/polyethylene glycol block copolymer. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### EXAMPLE 7

A coating composition was produced in substantially the same manner as in Example 3, except that, as an organic block copolymer, a trimethoxy-glycerol/polypropylene glycol/polyethylene glycol block copolymer was used, which was obtained by modifying, with a methoxy group, each terminal group of a glycerol/ polypropylene glycol/polyethylene glycol block copolymer (which is a branched block copolymer). Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### EXAMPLE 8

A coating composition was produced in substantially the same manner as in Example 4, except that, as an organic block copolymer, a dimethoxy-polypropylene glycol/polyethylene glycol block copolymer was used, which was obtained by modifying both terminals of a polypropylene glycol/polyethylene glycol block copolymer with a methoxy group. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### EXAMPLE 9

A coating composition was produced in substantially the same manner as in Example 5, except that, instead of the dimethoxy-polyethylene glycol/polypropylene glycol/polyethylene glycol block copolymer, a mixture of 11.50 g of a 50% by weight ethanol solution of dimethoxy-polyethylene glycol and 70.4 g of a 50% by weight ethanol solution of dimethoxy-polyethylene glycol/polypropylene glycol/polyethylene glycol block copolymer was used, wherein, in the mixture, the weight ratio of the ethanol solution of dimethoxy-polyethylene glycol to the ethanol solution of dimethoxy-polyethylene glycol/polypropylene glycol/polyethylene glycol block copolymer was 1/7. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### COMPARATIVE EXAMPLE 5

A coating composition was produced in substantially the same manner as in Example 5, except that, instead of the dimethoxy-polyethylene glycol/polypropylene glycol/polyethylene glycol block copolymer, a polymer obtained by modifying, with a methoxy group, both terminals of a polyethylene glycol having a weight average molecular weight of 600 was used. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### EXAMPLES 10 TO 13

In Examples 10, 11, 12 and 13, coating compositions were, respectively, produced in substantially the same manners as in Examples 5, 6, 7 and 8, except that a combination of methyltriethoxysilane (0.6 mol) and 1,2-bis(triethoxysilyl)ethane (0.4 mol, in terms of the amount of a silicon atom) was used as an alkoxysilane. Properties of the obtained coating compositions were measured, calculated and evaluated by the above-mentioned methods. The results are shown in Table.

Using each of the coating compositions individually, porous silica insulating thin films were obtained in substantially the same manner as in Example 1. Properties of the obtained thin films were measured, calculated and evaluated by the above-mentioned methods. The results are shown in Table.

### COMPARATIVE EXAMPLE 6

A coating composition was produced in substantially the same manner as in Example 10, except that, instead of the dimethoxy-polyethylene glycol/polypropylene glycol/polyethylene glycol block copolymer (which is an organic block copolymer), a polymer obtained by modifying, with a methoxy group, both terminals of a polyethylene glycol having a weight average molecular weight of 600 was used. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### EXAMPLES 14 TO 17

In Examples 14, 15, 16 and 17, coating compositions were, respectively, produced in substantially the same manners as in Examples 5, 6, 7 and 8, except that a combination of methyltriethoxysilane (0.4 mol), 1,2-bis(triethoxysilyl)ethane (0.4 mol, in terms of the amount of a silicon atom) and tetraethoxysilane (0.2 mol) was used as an alkoxysilane. Properties of the obtained coating compositions were measured, calculated and evaluated by the above-mentioned methods. The results are shown in Table.

Using each of the coating compositions individually, porous silica insulating thin films were obtained in substantially the same manner as in Example 1. Properties of the obtained thin films were measured, calculated and evaluated by the above-mentioned methods. The results are shown in Table.

### COMPARATIVE EXAMPLE 7

A coating composition was produced in substantially the same manner as in Example 14, except that, instead of the dimethoxy-polyethylene glycol/polypropylene glycol/polyethylene glycol block copolymer (which is an organic block copolymer), a polymer obtained by modifying, with a methoxy group, both terminals of a polyethylene glycol having a weight average molecular weight of 600 was used. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### COMPARATIVE EXAMPLE 8

A coating composition was produced in substantially the same manner as in Example 5, except that, instead of an organic block copolymer, a dimethoxypolypropylene glycol having a weight average molecular weight of 700 was used. Properties of the obtained coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

### EXAMPLE 18 TO 26

In Examples 18, 19, 20, 21, 22, 23, 24, 25 and 26, coating compositions were, respectively, produced in substantially the same manners as in Examples 5, 6, 7, 10, 11, 12, 14, 15 and 16, except that the polymer/silica weight ratio in each of the obtained coating compositions was changed from 0.6 to 0.5, and that each of combinations of tetramethylammonium hydroxide and acetic acid was individually used after each of the reaction mixtures was individually concentrated, so that the amounts of tetramethylammonium hydroxide and acetic acid in each of the coating compositions were, respectively, 20 ppm by weight and 0.1% by weight, based on the weight of the coating composition. Properties of the coating compositions were measured, calculated and evaluated by the above-mentioned methods. The results are shown in Table.

Using each of the coating compositions individually, porous silica insulating thin films were obtained in substantially the same manner as in Example 1. Properties of the obtained thin films were measured, calculated and evaluated by the above-mentioned methods. The results are shown in Table.

In each of Examples 18 to 26 in which a quaternary ammonium salt was used, by changing the polymer/silica weight ratio to 0.5 from 0.6 used in Examples 5 to 7 and 10 to 16, a porous silica insulating thin film having a relative dielectric constant of 2.3 was obtained, as in Examples 5 to 7 and 10 to 16 where a quaternary ammonium salt was not used.

### COMPARATIVE EXAMPLES 9 TO 11

In Comparative Examples 9, 10 and 11, coating compositions were, respectively, produced in substantially the same manners as in Examples 18, 19 and 20, except that reaction mixtures were obtained by using 0.3 g of a 2% by weight aqueous solution of tetramethylammonium hydroxide (the amount of tetramethylammonium hydroxide in the solution was 3×10⁻⁵ equivalents, relative to the alkoxy groups in the alkoxysilanes) instead of the 0.9% by weight aqueous solution of oxalic acid, and, after removal of ethanol by distillation, each of combinations of tetramethylammonium hydroxide, acetic acid and oxalic acid was individually used, so that the amounts of tetramethylammonium hydroxide, acetic acid and oxalic acid in each of the obtained coating compositions were, respectively, 20 ppm by weight, 0.1% by weight and 4 ppm by weight, based on the weight of the coating composition. Properties of the coating compositions were measured, calculated and evaluated by the above-mentioned methods. The results are shown in Table.

Using each of the coating compositions individually, porous silica insulating thin films were obtained in substantially the same manner as in Example 1. Properties of the obtained thin films were measured, calculated and evaluated by the above-mentioned methods. The results are shown in Table.

As seen from the results of Comparative Examples 9 to 11, when tetramethylammonium hydroxide was used as a catalyst, the difference between the skeletal density of the thin film and the apparent density of the thin film was 0.1 g/cm³ or less, and the thin film had a Young's modulus of 4 GPa or less, which was at an unsatisfactory level.

### COMPARATIVE EXAMPLE 12

A coating composition was produced in substantially the same manner as in Example 24, except that, in the final step in the process for producing the coating composition, only tetramethylammonium hydroxide was added instead of the combination of tetramethylammonium hydroxide and acetic acid, so that the amount of tetramethylammonium hydroxide in the coating composition was 20 ppm by weight, based on the weight of the coating composition. Properties of the coating composition were measured, calculated and evaluated by the above-mentioned methods. The results are shown in Table. The coating composition had a pH value of 7.2.

Using the coating composition, a porous silica insulating thin film was obtained in substantially the same manner as in Example 1. Properties of the obtained thin film were measured, calculated and evaluated by the above-mentioned methods. The results are shown in Table.

The thin film obtained in Comparative Example 12 had a relative dielectric constant of 2.3 and a Young's modulus of 6.4 GPa, each of which was about the same as that of the thin film obtained in Example 24 and was at a satisfactory level. However, the coating composition obtained in Comparative Example 12 had poor storage stability. Specifically, when the coating composition was stored at 23° C., gelation occurred seven days after the start of storing, so that the coating composition lost its fluidity.

### EXAMPLE 27

A coating composition was produced in substantially the same manner as in Example 24, except that, in the final step in the process for producing the coating composition, instead of a combination of tetramethylammonium hydroxide and acetic acid, a combination of tetramethylammonium hydroxide and sulfuric acid was used so that the amounts of tetramethylammonium hydroxide and sulfuric acid in the obtained coating composition were, respectively, 20 ppm by weight and 0.1% by weight, based on the weight of the coating composition. Properties of the coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

The thin film obtained in Example 27 had a Young's modulus of 6.4 GPa, which was about the same as that of the thin film obtained in Example 24 and was at a satisfactory level. However, the thin film obtained in Example 27 had a relative dielectric constant of 2.4, which was slightly higher than that of the thin film obtained in Example 24.

Further, an additional experiment was conducted to produce a coating composition having a polymer/silica weight ratio of 0.6. Using the produced coating composition, a porous silica insulating thin film having a relative dielectric constant of 2.3 was obtained. This thin film had a Young's modulus of 5.4 GPa, which was at a fairly satisfactory level.

### EXAMPLE 28

A coating composition was produced in substantially the same manner as in Example 24, except that, in the final step in the process for producing the coating composition, instead of a combination of tetramethylammonium hydroxide and acetic acid, a combination of tetramethylammonium hydroxide and hydrochloric acid was used so that the amounts of tetramethylammonium hydroxide and hydrochloric acid in the obtained coating composition were, respectively, 20 ppm by weight and 0.5% by weight, based on the weight of the coating composition. Properties of the coating composition were measured, calculated and evaluated by the above-mentioned methods. The results are shown in Table.

Using the coating composition, a porous silica insulating thin film was obtained in substantially the same manner as in Example 1. Properties of the obtained thin film were measured, calculated and evaluated by the above-mentioned methods. The results are shown in Table.

The thin film obtained in Example 27 had a Young's modulus of 6.3 GPa, which was about the same as that of the thin film obtained in Example 24 and was at a satisfactory level. However, the thin film obtained in Example 27 had a relative dielectric constant of 2.4, which was slightly higher than that of the thin film obtained in Example 24.

Further, an additional experiment was conducted to produce a coating composition having a polymer/silica weight ratio of 0.6. Using the produced coating composition, a porous silica insulating thin film having a relative dielectric constant of 2.3 was obtained. This thin film had a Young's modulus of 5.2 GPa, which was at a fairly satisfactory level.

### EXAMPLES 29 TO 31

In Examples 29, 30 and 31, coating compositions were produced in substantially the same manner as in Example 24, except that the final step in the process for producing the coating composition was modified as follows: in Example 29, ammonia was used instead of ammonia tetramethylammonium hydroxide so that the amount of ammonia in the obtained coating composition was 10 ppm by weight, based on the weight of the coating composition; in Example 30, triethylamine was used instead of ammonia tetramethylammonium hydroxide so that the amount of triethylamine in the obtained coating composition was 10 ppm by weight, based on the weight of the coating composition; and, in Example 31, triethanolamine was used instead of ammonia tetramethylammonium hydroxide so that the amount of triethanolamine in the obtained coating composition was 10 ppm by weight, based on the weight of the coating composition. Properties of the coating compositions were measured, calculated and evaluated by the above-mentioned methods. The results are shown in Table.

Using each of the coating compositions individually, porous silica insulating thin films were obtained in substantially the same manner as in Example 1. Properties of the obtained thin films were measured, calculated and evaluated by the above-mentioned methods. The results are shown in Table.

In each of Examples 29 to 31, the obtained thin film had a Young's modulus in the range of from 6.1 to 6.3 GPa (which was about the same as that of the thin film obtained in Example 24), but had a relative dielectric constant of 2.4 (which was slightly higher than that of the thin film obtained in Example 24).

Further, in each of Examples 29 to 31, an additional experiment was conducted to produce a coating composition having a polymer/silica weight ratio of 0.6. Using the produced coating composition, a porous silica insulating thin film having a relative dielectric constant of 2.3 was obtained. Each of the thin films produced in the additional experiments had a Young's modulus in the range of from 5.0 to 5.4 GPa, which was at a fairly satisfactory level.

### EXAMPLE 32

A coating composition was produced in substantially the same manner as in Example 24, except that the silica precursor concentration and polymer concentration of the obtained coating composition became 6% by weight and 3% by weight, respectively.

Using the produced coating composition, a porous silica insulating thin film was produced on a silicon wafer in substantially the same manner as in Example 1.

On the produced thin film, an organic insulating layer precursor (trade name: SiLK; manufactured and sold by The Dow Chemical Co., U.S.A.) was spin-coated, followed by calcination at 400° C. for 30 minutes in a nitrogen atmosphere, thereby forming an organic insulating thin film and a mixed thin film. Thus, an insulating laminate structure comprising an inorganic insulating layer comprised of a porous silica insulating thin film, an organic insulating layer comprised of an organic thin film, and a mixed layer comprised of a mixed thin film was obtained, wherein the mixed layer was disposed between the inorganic insulating layer and the organic insulating layer.

The inorganic insulating layer (comprised of a porous silica insulating thin film) had a density of 0.95 g/cm³ and a thickness of 297 nm, and the organic insulating layer (comprised of an organic thin film) had a density of 1.04 g/cm³ and a thickness of 552 nm. Further, the mixed layer had a density of 1.25 g/cm³. Since the mixed layer had a density higher than those of the inorganic insulating layer and the organic insulating layer, it was expected that the mixed layer had a relative dielectric constant which is higher than those of the inorganic insulating layer and the organic insulating layer. However, the mixed layer had a thickness as small as 6 nm. Therefore, the influence of the mixed layer on increase in the relative dielectric constant of the laminate structure was very small.

Both surfaces of the laminate structure and interfaces between the layers constituting the laminate structure were extremely smooth. Specifically, the interface between the silicon wafer and the inorganic insulating layer (i.e., the surface of the inorganic insulating layer, which surface was contacted with the silicon wafer) exhibited a roughness of 0.3 nm; the interface between the inorganic insulating layer and the mixed layer exhibited a roughness of 0.5 nm; the interface between the mixed layer and the organic layer exhibited a roughness of 0.5 nm; and the outer surface of the organic layer (which formed the outermost layer of the laminate structure) exhibited a roughness of 0.3 nm.

TABLE

| | Component (A) | | | Component (B) | | Polymer/silica | Catalyst |
|---|---|---|---|---|---|---|---|
| | Si_{MTES}/mol | Si_{BTSE}/mol | Si_{TEOS}/mol | Type of polymer (B) | Timing of addition | weight ratio | Type of catalyst |
| Ex. 1 | 0.6 | 0 | 0.4 | EO—PO—EO | Before | 0.60 | C₂H₂O₄ |
| Ex. 2 | 0.6 | 0 | 0.4 | EO—PTMG—EO | Before | 0.60 | C₂H₂O₄ |
| Ex. 3 | 0.6 | 0 | 0.4 | G(PO—EO)₃ | Before | 0.60 | C₂H₂O₄ |
| Ex. 4 | 0.6 | 0 | 0.4 | EG—PO | Before | 0.60 | C₂H₂O₄ |
| Comp. Ex. 1 | 0.6 | 0 | 0.4 | EO | Before | 0.60 | C₂H₂O₄ |
| Comp. Ex. 2 | 0.6 | 0 | 0.4 | EO—PO—EO | After | 0.60 | C₂H₂O₄ |
| Comp. Ex. 3 | 0.6 | 0 | 0.4 | EO—PTMG—EO | After | 0.60 | C₂H₂O₄ |
| Comp. Ex. 4 | 0.6 | 0 | 0.4 | G(PO—EO)₃ | After | 0.60 | C₂H₂O₄ |
| Ex. 5 | 0.6 | 0 | 0.4 | DM—EO—PO—EO | Before | 0.60 | C₂H₂O₄ |
| Ex. 6 | 0.6 | 0 | 0.4 | DM—EO—PTMG—EO | Before | 0.60 | C₂H₂O₄ |
| Ex. 7 | 0.6 | 0 | 0.4 | TM—G(PO—EO)₃ | Before | 0.60 | C₂H₂O₄ |
| Ex. 8 | 0.6 | 0 | 0.4 | DM—EO—PO | Before | 0.60 | C₂H₂O₄ |
| Ex. 9 | 0.6 | 0 | 0.4 | DM—EO—PO—EO/DM—EO | Before | 0.60 | C₂H₂O₄ |
| | | | | mixture (weight ratio = 7/1) | | | |
| Comp. Ex. 5 | 0.6 | 0 | 0.4 | DM—EO | Before | 0.60 | C₂H₂O₄ |
| Ex. 10 | 0.6 | 0.4 | 0 | DM—EO—PO—EO | Before | 0.60 | C₂H₂O₄ |
| Ex. 11 | 0.6 | 0.4 | 0 | DM—EO—PTMG—EO | Before | 0.60 | C₂H₂O₄ |
| Ex. 12 | 0.6 | 0.4 | 0 | TM—G(PO—EO)₃ | Before | 0.60 | C₂H₂O₄ |
| Ex. 13 | 0.6 | 0.4 | 0 | DM—EO—PO | Before | 0.60 | C₂H₂O₄ |
| Comp. Ex. 6 | 0.6 | 0.4 | 0 | DM—EO | Before | 0.60 | C₂H₂O₄ |
| Ex. 14 | 0.4 | 0.4 | 0.2 | DM—EO—PO—EO | Before | 0.60 | C₂H₂O₄ |
| Ex. 15 | 0.4 | 0.4 | 0.2 | DM—EO—PTMG—EO | Before | 0.60 | C₂H₂O₄ |
| Ex. 16 | 0.4 | 0.4 | 0.2 | TM—G(PO—EO)₃ | Before | 0.60 | C₂H₂O₄ |
| Ex. 17 | 0.4 | 0.4 | 0.2 | DM—EO—PO | Before | 0.60 | C₂H₂O₄ |
| Comp. Ex. 7 | 0.4 | 0.4 | 0.2 | DM—EO | Before | 0.60 | C₂H₂O₄ |
| Comp. Ex. 8 | 0.6 | 0 | 0.4 | DM—PO | Before | 0.60 | C₂H₂O₄ |
| Ex. 18 | 0.6 | 0 | 0.4 | DM—EO—PO—EO | Before | 0.50 | C₂H₂O₄ |
| Ex. 19 | 0.6 | 0 | 0.4 | DM—EO—PTMG—EO | Before | 0.50 | C₂H₂O₄ |
| Ex. 20 | 0.6 | 0 | 0.4 | TM—G(PO—EO)₃ | Before | 0.50 | C₂H₂O₄ |
| Ex. 21 | 0.6 | 0.4 | 0 | DM—EO—PO—EO | Before | 0.50 | C₂H₂O₄ |
| Ex. 22 | 0.6 | 0.4 | 0 | DM—EO—PTMG—EO | Before | 0.50 | C₂H₂O₄ |
| Ex. 23 | 0.6 | 0.4 | 0 | TM—G(PO—EO)₃ | Before | 0.50 | C₂H₂O₄ |
| Ex. 24 | 0.4 | 0.4 | 0.2 | DM—EO—PO—EO | Before | 0.50 | C₂H₂O₄ |
| Ex. 25 | 0.4 | 0.4 | 0.2 | DM—EO—PTMG—EO | Before | 0.50 | C₂H₂O₄ |
| Ex. 26 | 0.4 | 0.4 | 0.2 | TM—G(PO—EO)₃ | Before | 0.50 | C₂H₂O₄ |
| Comp. Ex. 9 | 0.6 | 0 | 0.4 | DM—EO—PO—EO | Before | 0.50 | TMAH |
| Comp. Ex. 10 | 0.6 | 0 | 0.4 | DM—EO—PTMG—EO | Before | 0.50 | TMAH |
| Comp. Ex. 11 | 0.6 | 0 | 0.4 | TM—G(PO—EO)₃ | Before | 0.50 | TMAH |
| Comp. Ex. 12 | 0.4 | 0.4 | 0.2 | DM—EO—PO—EO | Before | 0.50 | C₂H₂O₄ |
| Ex. 27 | 0.4 | 0.4 | 0.2 | DM—EO—PO—EO | Before | 0.50 | C₂H₂O₄ |
| Ex. 28 | 0.4 | 0.4 | 0.2 | DM—EO—PO—EO | Before | 0.50 | C₂H₂O₄ |
| Ex. 29 | 0.4 | 0.4 | 0.2 | DM—EO—PO—EO | Before | 0.50 | C₂H₂O₄ |
| Ex. 30 | 0.4 | 0.4 | 0.2 | DM—EO—PO—EO | Before | 0.50 | C₂H₂O₄ |
| Ex. 31 | 0.4 | 0.4 | 0.2 | DM—EO—PO—EO | Before | 0.50 | C₂H₂O₄ |

Formulation of the coating composition

| | | | | | | | | | -Methylene- |
|---|---|---|---|---|---|---|---|---|---|
| | | | | Component | | Concentration | | | Si |
| | Silica | | | (C) ratio | | of | Trifunctional | -Methylene- | ratio |
| | precursor | polymer | | (including | Component | component | silane | Si | (in the |
| | concentration | ratio | component (C) | catalyst) | (D) | (D) | ratio | ratio | film) |
| Ex. 1 | 10% | 6% | C₂H₂O₄ | 4 ppm | — | — | 60% | 0% | 0% |
| Ex. 2 | 10% | 6% | C₂H₂O₄ | 4 ppm | — | — | 60% | 0% | 0% |
| Ex. 3 | 10% | 6% | C₂H₂O₄ | 4 ppm | — | — | 60% | 0% | 0% |
| Ex. 4 | 10% | 6% | C₂H₂O₄ | 4 ppm | — | — | 60% | 0% | 0% |
| Comp. Ex. 1 | 10% | 6% | C₂H₂O₄ | 4 ppm | — | — | 60% | 0% | 0% |
| Comp. Ex. 2 | 10% | 6% | C₂H₂O₄ | 4 ppm | — | — | 60% | 0% | 0% |
| Comp. Ex. 3 | 10% | 6% | C₂H₂O₄ | 4 ppm | — | — | 60% | 0% | 0% |
| Comp. Ex. 4 | 10% | 6% | C₂H₂O₄ | 4 ppm | — | — | 60% | 0% | 0% |
| Ex. 5 | 10% | 6% | C₂H₂O₄ | 4 ppm | — | — | 60% | 0% | 0% |
| Ex. 6 | 10% | 6% | C₂H₂O₄ | 4 ppm | — | — | 60% | 0% | 0% |
| Ex. 7 | 10% | 6% | C₂H₂O₄ | 4 ppm | — | — | 60% | 0% | 0% |
| Ex. 8 | 10% | 6% | C₂H₂O₄ | 4 ppm | — | — | 60% | 0% | 0% |
| Ex. 9 | 10% | 6% | C₂H₂O₄ | 4 ppm | — | — | 60% | 0% | 0% |
| Comp. Ex. 5 | 10% | 6% | C₂H₂O₄ | 4 ppm | — | — | 60% | 0% | 0% |
| Ex. 10 | 10% | 6% | C₂H₂O₄ | 4 ppm | — | — | 60% | 40% | 40% |
| Ex. 11 | 10% | 6% | C₂H₂O₄ | 4 ppm | — | — | 60% | 40% | 40% |
| Ex. 12 | 10% | 6% | C₂H₂O₄ | 4 ppm | — | — | 60% | 40% | 40% |
| Ex. 13 | 10% | 6% | C₂H₂O₄ | 4 ppm | — | — | 60% | 40% | 40% |
| Comp. Ex. 6 | 10% | 6% | C₂H₂O₄ | 4 ppm | — | — | 60% | 40% | 40% |
| Ex. 14 | 10% | 6% | C₂H₂O₄ | 4 ppm | — | — | 40% | 40% | 40% |
| Ex. 15 | 10% | 6% | C₂H₂O₄ | 4 ppm | — | — | 40% | 40% | 40% |
| Ex. 16 | 10% | 6% | C₂H₂O₄ | 4 ppm | — | — | 40% | 40% | 40% |
| Ex. 17 | 10% | 6% | C₂H₂O₄ | 4 ppm | — | — | 40% | 40% | 40% |
| Comp. Ex. 7 | 10% | 6% | C₂H₂O₄ | 4 ppm | — | — | 40% | 40% | 40% |
| Comp. Ex. 8 | 10% | 6% | C₂H₂O₄ | 4 ppm | — | — | 60% | 0% | 0% |
| Ex. 18 | 10% | 5% | C₂H₄O₂, C₂H₂O₄ | 0.1% | TMAH | 20 ppm | 60% | 0% | 0% |
| Ex. 19 | 10% | 5% | C₂H₄O₂, C₂H₂O₄ | 0.1% | TMAH | 20 ppm | 60% | 0% | 0% |
| Ex. 20 | 10% | 5% | C₂H₄O₂, C₂H₂O₄ | 0.1% | TMAH | 20 ppm | 60% | 0% | 0% |
| Ex. 21 | 10% | 5% | C₂H₄O₂, C₂H₂O₄ | 0.1% | TMAH | 20 ppm | 60% | 40% | 40% |
| Ex. 22 | 10% | 5% | C₂H₄O₂, C₂H₂O₄ | 0.1% | TMAH | 20 ppm | 60% | 40% | 40% |
| Ex. 23 | 10% | 5% | C₂H₄O₂, C₂H₂O₄ | 0.1% | TMAH | 20 ppm | 60% | 40% | 40% |
| Ex. 24 | 10% | 5% | C₂H₄O₂, C₂H₂O₄ | 0.1% | TMAH | 20 ppm | 40% | 40% | 40% |
| Ex. 25 | 10% | 5% | C₂H₄O₂, C₂H₂O₄ | 0.1% | TMAH | 20 ppm | 40% | 40% | 40% |
| Ex. 26 | 10% | 5% | C₂H₄O₂, C₂H₂O₄ | 0.1% | TMAH | 20 ppm | 40% | 40% | 40% |
| Comp. Ex. 9 | 10% | 5% | C₂H₄O₂, C₂H₂O₄ | 0.1% | TMAH | 20 ppm | 60% | 0% | 0% |
| Comp. Ex. 10 | 10% | 5% | C₂H₄O₂, C₂H₂O₄ | 0.1% | TMAH | 20 ppm | 60% | 0% | 0% |
| Comp. Ex. 11 | 10% | 5% | C₂H₄O₂, C₂H₂O₄ | 0.1% | TMAH | 20 ppm | 60% | 0% | 0% |
| Comp. Ex. 12 | 10% | 5% | C₂H₂O₄ | 4 ppm | TMAH | 20 ppm | 40% | 40% | 40% |
| Ex. 27 | 10% | 5% | H₂SO₄, C₂H₂O₄ | 0.1% | TMAH | 20 ppm | 40% | 40% | 40% |
| Ex. 28 | 10% | 5% | HCl, C₂H₂O₄ | 0.5% | TMAH | 20 ppm | 40% | 40% | 40% |
| Ex. 29 | 10% | 5% | C₂H₄O₂, C₂H₂O₄ | 0.1% | NH₃ | 20 ppm | 40% | 40% | 40% |
| Ex. 30 | 10% | 5% | C₂H₄O₂, C₂H₂O₄ | 0.1% | TMA | 20 ppm | 40% | 40% | 40% |
| Ex. 31 | 10% | 5% | C₂H₄O₂, C₂H₂O₄ | 0.1% | TEA | 20 ppm | 40% | 40% | 40% |

Result of evaluation

| | Relative | Young | | ρ_{w} − ρₐᵥₑ | Gas | Storage |
|---|---|---|---|---|---|---|
| | dielectric constant | modulus (GPa) | Hydrophobic property | (gcm⁻³) | yield | stability |
| Ex. 1 | 2.3 | 4.7 | Good | >0.2 | Fairly | Good |
| | | | | | good | |
| Ex. 2 | 2.3 | 4.6 | Good | >0.2 | Fairly | Good |
| | | | | | good | |
| Ex. 3 | 2.3 | 4.4 | Good | >0.2 | Fairly | Good |
| | | | | | good | |
| Ex. 4 | 2.3 | 4.0 | Good | 0.1 to | Fairly | Good |
| | | | | 0.2 | good | |
| Comp. Ex. 1 | 2.3 | 3.5 | Good | <0.1 | Fairly | — |
| | | | | | good | |
| Comp. Ex. 2 | 2.3 | 3.9 | Good | <0.1 | Fairly | Good |
| | | | | | good | |
| Comp. Ex. 3 | 2.3 | 3.8 | Good | <0.1 | Fairly | Good |
| | | | | | good | |
| Comp. Ex. 4 | 2.3 | 3.8 | Good | <0.1 | Fairly | Good |
| | | | | | good | |
| Ex. 5 | 2.3 | 4.8 | Good | >0.2 | Good | Good |
| Ex. 6 | 2.3 | 4.6 | Good | >0.2 | Good | Good |
| Ex. 7 | 2.3 | 4.3 | Good | >0.2 | Good | Good |
| Ex. 8 | 2.3 | 4.0 | Good | 0.1 to | Good | Good |
| | | | | 0.2 | | |
| Ex. 9 | 2.3 | 4.6 | Good | >0.2 | Very | Good |
| | | | | | good | |
| Comp. Ex. 5 | 2.3 | 3.6 | Good | <0.1 | Good | — |
| Ex. 10 | 2.3 | 4.8 | Good | >0.2 | Good | Good |
| Ex. 11 | 2.3 | 4.7 | Good | >0.2 | Good | Good |
| Ex. 12 | 2.3 | 4.5 | Good | >0.2 | Good | Good |
| Ex. 13 | 2.3 | 4.0 | Good | 0.1 to | Good | Good |
| | | | | 0.2 | | |
| Comp. Ex. 6 | 2.3 | 3.6 | Good | <0.1 | Good | — |
| Ex. 14 | 2.3 | 5.5 | Good | >0.2 | Good | Good |
| Ex. 15 | 2.3 | 5.3 | Good | >0.2 | Good | Good |
| Ex. 16 | 2.3 | 5.2 | Good | >0.2 | Good | Good |
| Ex. 17 | 2.3 | 5.0 | Good | 0.1 to | Good | Good |
| | | | | 0.2 | | |
| Comp. Ex. 7 | 2.3 | 3.7 | Good | <0.1 | Good | — |
| Comp. Ex. 8 | 2.3 | 3.8 | Good | <0.1 | Good | — |
| Ex. 18 | 2.3 | 6.1 | Very good | >0.2 | Good | Good |
| Ex. 19 | 2.3 | 6.0 | Very good | >0.2 | Good | Good |
| Ex. 20 | 2.3 | 6.0 | Very good | >0.2 | Good | Good |
| Ex. 21 | 2.3 | 6.2 | Very good | >0.2 | Good | Good |
| Ex. 22 | 2.3 | 6.1 | Very good | >0.2 | Good | Good |
| Ex. 23 | 2.3 | 6.1 | Very good | >0.2 | Good | Good |
| Ex. 24 | 2.3 | 6.6 | Very good | >0.2 | Good | Good |
| Ex. 25 | 2.3 | 6.3 | Very good | >0.2 | Good | Good |
| Ex. 26 | 2.3 | 6.1 | Very good | >0.2 | Good | Good |
| Comp. Ex. 9 | 2.3 | 3.9 | Good | <0.1 | Good | Fairly |
| | | | | | | good |
| Comp. Ex. 10 | 2.3 | 3.8 | Good | <0.1 | Good | Fairly |
| | | | | | | good |
| Comp. Ex. 11 | 2.3 | 3.9 | Good | <0.1 | Good | Fairly |
| | | | | | | good |
| Comp. Ex. 12 | 2.3 | 6.4 | Very good | >0.2 | Good | Poor |
| Ex. 27 | 2.4 | 6.2 | Fairly good | >0.2 | Good | Good |
| Ex. 28 | 2.4 | 6.3 | Fairly good | >0.2 | Good | Good |
| Ex. 29 | 2.4 | 6.3 | Fairly good | >0.2 | Good | Good |
| Ex. 30 | 2.4 | 6.4 | Fairly good | >0.2 | Good | Good |
| Ex. 31 | 2.4 | 6.1 | Fairly good | >0.2 | Good | Good |

### Explanation on Abbreviation

| | |
|---|---|
| EO-PO-EO | Polyethylene/glycol-polypropylene glycol/ |
| | polyethylene glycol block copolymer |
| EO-PTMG-EO | Polyethylene glycol/polytetramethylene glycol/ |
| | polyethylene glycol block copolymer |
| G(PO-EO)₃ | Glycerol-(polypropylene glycol-polyethylene |
| | glycol)₃ block copolymer |
| EO-PO | Polyethylene glycol/polypropylene glycol block |
| | copolymer |
| EO | Polyethylene glycol |
| PO | Polypropylene glycol |
| DM- | Dimethoxy- |
| TM- | Trimethoxy- |
| C₂H₂O₄ | Oxalic acid |
| TMAH | Tetramethylammonium hydroxide |
| C₂H₄O₂ | Acetic acid |
| H₂SO₄ | Sulfuric acid |
| NH₃ | Ammonia |
| HCl | Hydrochloric acid |
| TMA | Trimethylamine |
| TEA | Triethanolamine |
| Si_{MTES}/mol | Molar amount of Si atoms in methyltriethoxysilane |
| Si_{BTSE}/mol | Molar amount of Si atoms in l,2- |
| | bis(trithoxysilyl)ethane |
| Si_{TEOS}/mol | Molar amount of Si atoms in tetraethoxysilane |
| Timing of addition | Before: an organic polymer was added before |
| | hydrolysis/polycondensation of the alkoxysilane(s) |
| | After: an organic polymer was added after |
| | hydrolysis/polycondensation of the alkoxysilane(s) |
| Polymer ratio | Weight ratio of the organic polymer used as a raw |
| | material to the silica formed from the |
| | alkoxysilane(s) used as a raw material |

### Industrial Applicability

The coating composition of the present invention exhibits an excellent storage stability. The porous silica insulating thin film obtained from the coating composition exhibits a satisfactorily low relative dielectric constant, an extremely high mechanical strength, an excellent hydrophobicity, a property that the amount of gas generated from the thin film during a via process can be suppressed to an extremely low level, and an excellent processability. Therefore, the coating composition of the present invention can be advantageously used for producing an excellent insulating laminate structure, an excellent multilevel interconnect and an excellent semiconductor device.

1. A coating composition for use in producing an insulating thin film, comprising:
(A) a silica precursor comprising at least one member selected from the group consisting of an alkoxysilane (a), an alkoxysilane (b), and hydrolysis/polycondensation products formed by hydrolysis/polycondensation reactions of said alkoxysilanes (a) and (b) under acidic conditions,
wherein:
said alkoxysilane (a) is represented by the following formula (1):
R¹ₙSi(OR²)₄₋ₙ (1)
wherein each R¹ independently represents a hydrogen atom, a straight chain or branched alkyl group having 1 to 6 carbon atoms, a vinyl group or a phenyl group, each R2 independently represents a straight chain or branched alkyl group having 1 to 6 carbon atoms and n represents an integer of from 0 to 3, and
said alkoxysilane (b) is represented by the following formula (2):
R³ₘ(R⁴O)₃₋ₘSi—(R⁷)ₚ—Si(OR⁵)_{3-q}R⁶q (2)
wherein each R³ independently represents a hydrogen atom, a straight chain or branched alkyl group having 1 to 6 carbon atoms, a vinyl group or a phenyl group, each R⁴ independently represents a straight chain or branched alkyl group having 1 to 6 carbon atoms, each R⁵ independently represents a straight chain or branched alkyl group having 1 to 6 carbon atoms, each R⁶ independently represents a hydrogen atom, a straight chain or branched alkyl group having 1 to 6 carbon atoms, a vinyl group or a phenyl group, R⁷ represents an oxygen atom, a phenylene group, or a group —(CH₂)ᵣ— in which r represents an integer of from 1 to 6, each of m and q independently represents an integer of from 0 to 2, and p represents 0 or 1; and
(B) an organic polymer containing 20% by weight or more, based on the weight of said organic polymer, of a straight chain or branched organic block copolymer,
said hydrolysis/polycondensation reactions for obtaining said silica precursor (A) being performed in the presence of said organic polymer (B),
said coating composition having a pH value of less than 7.

2. The coating composition according to claim 1, wherein said organic block copolymer has at least one terminal group which is inert to said silica precursor (A).

3. The coating composition according to claim 1 or 2, wherein said organic block copolymer contains a structure represented by the following formula (3):
—(R⁸O)ₓ—(R¹⁰)_{y}—(R⁹O)_{z}— (3)
wherein each of R⁸, R⁹ and R¹⁰ independently represents a straight chain or cyclic alkylene group having 1 to 10 carbon atoms with the proviso that not all of R⁸, R⁹ and R¹⁰ are the same, x represents an integer of from 2 to 200, y represents an integer of from 2 to 100, and z represents an integer of from 0 to 200.

4. The coating composition according to claim 3, wherein said organic block copolymer contains a structure of formula (3) with the proviso that R⁸ is the same as R⁹, and R¹⁰ is different from R⁸ and R⁹.

5. A method for producing a porous silica insulating thin film, which comprises the steps of:
(1) coating the composition of claim 1 or 2 on a substrate to form a thin film of the composition on the substrate,
(2) subjecting said thin film to gelation with respect to said silica precursor (A) to thereby obtain a silica/organic polymer composite thin film, and
(3) removing said organic polymer (B) from said silica/organic polymer composite thin film to thereby obtain a porous silica insulating thin film.

6. A porous silica insulating thin film obtained by the method of claim 5.

7. The porous silica insulating thin film according to claim 6, which has a group represented by the following formula (4):
—Si—(R)ₚ—Si— (4)
wherein R represents an oxygen atom or a group —(CH₂)ᵣ— in which r represents an integer of from 1 to 6, and p represents 0 or 1,
wherein the difference between the skeletal density of said porous silica insulating thin film and the apparent density of said porous silica insulating thin film is 0.2 or more,
wherein the thickness of said porous silica insulating thin film is 100 μm or less.

8. The porous silica insulating thin film according to claim 6 or 7, exhibiting a weight decrease ratio of 1% by weight or less as measured by thermogravimetric analysis (TGA) under conditions wherein the temperature of the porous silica insulating thin film is elevated at a rate of 10° C./min from room temperature to 425° C. and is maintained at 425° C. for 60 minutes.

9. An insulating laminate structure comprising an inorganic insulating layer comprised of the porous silica insulating thin film of claim 6 or 7 and an organic insulating layer comprised of an organic compound.

10. A multilevel interconnect comprising a plurality of insulating layers and circuits formed on said insulating layers, wherein at least one layer of said insulating layers is comprised of the porous silica insulating thin film of claim 6 or 7.

11. A semiconductor device comprising the multilevel interconnect of claim 10.

12. A multilevel interconnect comprising a plurality of insulating layers and circuits formed on said insulating layers, wherein at least one layer of said insulating layers is comprised of the insulating laminate structure of claim 9.

13. A semiconductor device comprising the multilevel interconnect of claim 11.

14. A coating composition for use in producing an insulating thin film, comprising:
(A) a silica precursor comprising at least one member selected from the group consisting of an alkoxysilane (a), an alkoxysilane (b), and hydrolysis/polycondensation products formed by hydrolysis/polycondensation reactions of said alkoxysilanes (a) and (b) under acidic conditions,
wherein:
said alkoxysilane (a) is represented by the following formula (1):
R¹ₙSi(OR²)₄₋ₙ (1)
wherein each R¹ independently represents a hydrogen atom, a straight chain or branched alkyl group having 1 to 6 carbon atoms, a vinyl group or a phenyl group, each R² independently represents a straight chain or branched alkyl group having 1 to 6 carbon atoms and n represents an integer of from 0 to 3, and
said alkoxysilane (b) is represented by the following formula (2):
R³ₘ(R⁴O)₃₋ₘSi—(R⁷)ₚ—Si(OR⁵)_{3-q}R⁶_{q} (2)
wherein each R³ independently represents a hydrogen atom, a straight chain or branched alkyl group having 1 to 6 carbon atoms, a vinyl group or a phenyl group, each R⁴ independently represents a straight chain or branched alkyl group having 1 to 6 carbon atoms, each R⁵ independently represents a straight chain or branched alkyl group having 1 to 6 carbon atoms, each R⁶ independently represents a hydrogen atom, a straight chain or branched alkyl group having 1 to 6 carbon atoms, a vinyl group or a phenyl group, R⁷ represents an oxygen atom, a phenylene group, or a group —(CH₂)ᵣ— in which r represents an integer of from 1 to 6, each of m and q independently represents an integer of from 0 to 2, and p represents 0 or 1; and
(B) an organic polymer containing 20% by weight or more, based on the weight of said organic polymer, of a straight chain or branched organic block copolymer;
(C) an acid having an electrolytic dissociation exponent (pKa) of from 1 to 11; and
(D) a quaternary ammonium salt,
wherein said coating composition has a pH value of less than 7.

15. The coating composition according to claim 14, wherein said hydrolysis/polycondensation reactions for obtaining said silica precursor (A) are performed in the presence of said organic copolymer (B).

16. The coating composition according to claim 14 or 15, wherein said organic block copolymer has at least one terminal group which is inert to said silica precursor (A).

17. The coating composition according to claim 14, wherein said organic block copolymer contains a structure represented by the following formula (3):
—(R⁸O)ₓ—(R¹⁰O)_{y}—(R⁹O)_{z—} (3)
wherein each of R⁸, R⁹ and R¹⁰ independently represents a straight chain or cyclic alkylene group having 1 to 10 carbon atoms with the proviso that not all of R⁸, R⁹ and R¹⁰ are the same, x represents an integer of from 2 to 200, y represents an integer of from 2 to 100, and z represents an integer of from 0 to 200.

18. The coating composition according to claim 17, wherein said organic block copolymer contains a structure of formula (3) with the proviso that R⁸ is the same as R⁹, and R¹⁰ is different from R⁸ and R⁹.

19. A method for producing a porous silica insulating thin film, which comprises the steps of:
(1) coating the composition of claim 14 or 15 on a substrate to form a thin film of the composition on the substrate,
(2) subjecting said thin film to gelation with respect to said silica precursor (A) to thereby obtain a silica/organic polymer composite thin film, and
(3) removing said organic polymer (B) from said silica/organic polymer composite thin film to thereby obtain a porous silica insulating thin film.

20. A porous silica insulating thin film obtained by the method of claim 19.

21. The porous silica insulating thin film according to claim 20, which has a group represented by the following formula (4):
—Si—(R)ₚ—Si— (4)
wherein R represents an oxygen atom or a group —(CH₂)ᵣ— in which r represents an integer of from 1 to 6, and p represents 0 or 1,
wherein the difference between the skeletal density of said porous silica insulating thin film and the apparent density of said porous silica insulating thin film is 0.2 or more,
wherein the thickness of said porous silica insulating thin film is 100 μm or less.

22. The porous silica insulating thin film according to claim 20 or 21, exhibiting a weight decrease ratio of 1% by weight or less as measured by thermogravimetric analysis (TGA) under conditions wherein the temperature of the porous silica insulating thin film is elevated at a rate of 10° C./min from room temperature to 425° C. and is maintained at 425° C. for 60 minutes.

23. An insulating laminate structure comprising an inorganic insulating layer comprised of the porous silica insulating thin film of claim 20 or 21 and an organic insulating layer comprised of an organic compound.

24. A multilevel interconnect comprising a plurality of insulating layers and circuits formed on said insulating layers, wherein at least one layer of said insulating layers is comprised of the porous silica insulating thin film of claim 20 or 21.

25. A semiconductor device comprising the multilevel interconnect of claim 24.

26. A multilevel interconnect comprising a plurality of insulating layers and circuits formed on said insulating layers, wherein at least one layer of said insulating layers is comprised of the insulating laminate structure of claim 23.

27. A semiconductor device comprising the multilevel interconnect of claim 26.
